(19) United States
(12) Patent Application Publication
(10) Pub. No.: US 2007/0057911 A1
(43) Pub. Date: Mar. 15, 2007

(54) System and method for wireless network content conversion for intuitively controlled portable displays

(76) Inventor: Sina Fateh, Sunnyvale, CA (US)

Correspondence Address: PERKINS COIE LLP, P.O. BOX 2168, MENLO PARK, CA, 94026, US

(21) Appl. No.: 11/225,867

(22) Filed: Sep. 12, 2005

(51) Int. Cl. G09G 5/00

(52) U.S. Cl. 345/156

(57) ABSTRACT

A system and method is described for converting wireless computer network rich content from display frames geared for Internet-connected PCs to display frames which are geared for wireless hand-held devices and sent over a wireless network. Such conversions are specifically for hand-held devices which use a system of instantaneous and intuitive visual access to visual data using motion control. The use of motion-controlled hand-held devices with such as system allows for the elimination of pen or button scrolling and wireless navigating. Frames are specifically converted to match a set of hand-held user preferences, match the display requirements of the device, and implement features which eliminate display problems normally present in hand-held wireless displays.

### FIELD OF THE INVENTION

The present invention teaches a computer software and hardware implemented system and method for the conversion of displayable computer content to content that is displayable for intuitively-controlled display operating systems in hand-held electronic devices, such as PDAs and cellular telephone screens.

### BACKGROUND OF THE INVENTION

Prior art FIG. 1A displays a traditional desktop computer display 10. The traditional computer 10 typically includes a display device 12, a keyboard 14, and a pointing device 16. The display device 12 is normally physically connected to the keyboard 14 and pointing device 16. The pointing device 16 and buttons 18 may be physically integrated into the keyboard 14.

The dominant form of display technology for personal computing devices is called a “raster” display. Prior art FIG. 1B shows a typical computer raster display. Such a display will “scan” lines of pixels at a certain frequency, usually greater than 30 Hz, primarily around 60 Hz. The frequency of the scans must be great enough so that flicker will not be noticed. A typical raster display will be between 45 and 100 pixels per inch also known as dpi (dots per inch). Normal quality resolution requires 3.75 MB of RAM in a 1280×1024×24 bit color per pixel display. A 300 dpi screen will require much more RAM.

The user can control the computer system using the pointing device 16 by making selections on the display device 12 which contains a content screen 15. For example, using the pointing device the user can scroll the viewing area by selecting the vertical 38 or horizontal 36 scroll bar. Although the desktop computer was sufficient for the average user, as manufacturing technology increased, personal computers began to become more portable, resulting in notebook and hand-held computers.

Notebook and hand-held computers are often made of two mechanically linked components, one essentially containing the display device 12 and the other, the keyboard 14 and pointing device 16. Hinges link these two mechanical components, with flexible ribbon cabling connecting the components and embedded in the hinging mechanism. The two components can be closed like a book, often latching to minimize inadvertent opening. The notebook greatly increased the portability of personal computers. In the mid 1990's, a new computer interface paradigm emerged which gave even greater freedom. This new interface is commonly known as the Personal Digital Assistant (PDA hereafter) 20 and is illustrated in Prior art FIG. 2

One of the first commercially successful PDAs was the Palm product line manufactured by 3Com. These machines are quite small, lightweight and relatively inexpensive, often fitting in a shirt pocket, weighing a few ounces, and costing less than $400 when introduced. These machines possess much less memory (around 2-8 MB of RAM) than a standard PC and also include a small display 28, but no physical keyboard. A pen-like pointing device 26, often stored next to or on the PDA 20, is applied to the display area 28 to support its user making choices and interacting with the PDA device 20. External communication is often established via a serial port in the PDA connecting to the cradle 22 connected by wire line 24 to a traditional computer 10. As will be appreciated, PDAs such as the PalmPilot™ have demonstrated the commercial reliability of this style of computer interface. The display area 28 is often quite small compared to traditional computer displays 12. In the case of the Palm product line, the display area 28 contains an array of 160 pixels by 160 pixels in a 2.5 inch by 2.5 inch (6 cm×6 cm) viewing area. Often, part of the display area is further allocated to menus and the like, further limiting the viewing area for a 2-D object such as a FAX page, however this problem has been partially addressed. The menu bar 34 found on most traditional computer-human interface displays 12 is usually invisible on a PDA display 28. The wireless PDA also contains an antenna 27 which can usually fold into the device.

Such hand-held electronic devices as described above are now prevalent and the features on these devices are continually expanding. The displays on hand-held devices are getting more complicated. Palm, Blackberry, Vigo and other manufacturers now make portable digital assistants which have wireless access to the Internet.

The benefits of these portable hand-held devices, which includes their size, portability, and reasonably low cost, also limits these devices' ability to display rich graphic content due to the limits of screen size and memory. The increasingly graphics-rich Internet does not presently account for the fact that hand-held wireless devices are usually connected to the Internet at a much lower bandwidth and significantly less data transfer speed than an ordinary personal computer would be able to handle. Some graphics intensive Internet sites freeze up normal personal computers with a normal supply of memory (typically greater than 300-1000 Megabytes of RAM on a PC, or 125-250 on a Macintosh). Such normal computers, which may be just a couple of years old are often unable to display some of the more complicated displays, indicating that such graphic display requirements would be unacceptable for an affordable small electronic device.

Another significant problem with displaying complicated graphics on a hand-held electronics screen is that a PDA screen which is typically 2.5×2.5, has 94 percent less area than a 12×9 standard 15 inch computer monitor. This means that a PDA screen can only display approximately 6 percent of a typical computer screen (although this may be helped by the elimination of control elements such as tool bars in a typical GUI operating system). Of course the graphics can simply be reduced by a factor of 16 but such a reduction in graphics size is usually unacceptable because text ceases to be readable and icons are not distinguishable. FIG. 3A illustrates a the resulting reduction in display size that would occur on a PDA screen.

Another problem is that most hand-held electronic devices do not have the same screen ratio as a standard computer display. A typical 15-inch computer display will be proportioned on the 640 pixel by 480 pixel ratio. This indicates a screen ratio of 4:3 length to width (12 inches by 9 inches) which is also present in the 800×600, 1152×864, and 1280×1024 ratio (which is actually a 5:4 ratio) options on a typical raster display. Other computer display formats use different ratios.

In comparison, the Palm PDA screen is typically 2.5 inches by 2.5 inches which is approximately a 1:1 ratio (width to length). This means that the Palm is more compact but cannot display graphics the same way a normal computer display will show them, even when scaled properly. A Palm has 160×160 screen (different models may vary) so the resolution will be a little better than a standard computer display resolution, but very limited because of the human perception of gray or two-tone scale. Hand-held computers running pseudo-PC display operating systems such as Window CE® may be more properly configured to display standard Internet graphics in the same proportion as they would be displayed on a typical computer display, but the ratio may still be different, because the screen will have be reduced to retain portability. The screen ratio problem is indicated by FIG. 3B.

FIG. 4 illustrates a sample cellphone browser system 30, which is comprised of a screen 31 and one or more navigating controls 32. Sprint and other cell phone makers also offer Internet browsing features on their cell phones screens, but the cell phone browsers are generally created by third parties. Originally, Phone.com, now Openwave.com, developed the microbrowser concept for cellphones. There are some severe inherent limitations to the concept of browsing with a cellphone. At a maximum of 1.5 inches by 1.5 inches cellular telephone screens will display approximately 2% of a 12″×9″ standard computer display. It is simply not practical to design web pages for devices this small. Also, a cellphone browser, needs two-dimensional selection to access links and must have a way to enter text.

Furthermore, many cellphone browsers cannot be upgraded and many phones have been sold with obsolete browser versions, and these phones will be in use for many years to come. Authors building microbrowser sites will have to deal with bad browsers built into good phones for the next five years. That prevents any rapid evolution of the type that created the modem PC web browser.

Also, cellphone browsers often have user interface flaws. For example many cellphones have a four-line or five-line screen. The top or bottom line may show icons, leaving three to four lines of text. The screen can generally be scrolled only one line at a time since usually there is no page-down key, ruling out reading anything longer than a few lines.

In some instances, web authors have created Internet sites for devices that do not have as much display capability as a standard computer display. However, the cost of Internet sites is in their development and implementation. It simply is impracticable to develop “another” Internet in which entities create websites in which wireless devices receive a much simpler set of graphics from the alternate computer networks.

Often accessibility for alternate wireless devices such as PDAs and cellphone browsers can be a problem on the web. Website creators too often worry more about a color scheme while ignoring things like the ALT tag, which allows alternative browsers, including screenreaders for the visually impaired access to the web. Good web authoring will convert easily to alternative user agents such as WebTV, handheld PalmOS or WinCE browsers, and even cellphone browsers. Authoring for accessibility enhances how well a site will work in future user agents, when the web becomes even more ubiquitous than it is already, especially for wireless devices which have become more prevalent in Europe than they are in the United States.

Turning next to prior art FIG. 5, an example of the web clipping process 50 will now be described. In step 52 a server loads a standard HTML page, in step 54, the HTML commands are checked for unacceptable content. Unacceptable content is usually comprised of text and graphics that require too many system resources to be displayed on a PDA device. In step 56 the unacceptable content is replaced with clipping commands that can be displayed on a PDA device. In step 58, the web clipping tag is activated and in step 59 loaded onto the server where an Internet page now can be read by a PDA device.

Palm, Inc. the leading manufacturer and developer of hand-held devices has allowed greater open-platform development regarding the technology used to run their PDAs. One solution to the amount of memory and display space available to a handheld device is to reduce the graphics in each frame presented. There are several ways in which graphical content can be translated for handheld devices: The first and most prevalent is the “web clipping” method. In web clipping computer graphics that would normally appear on a computer display are radically reconfigured to use much less memory and bandwidth. Web clipping was developed by Palm and other entities in order to minimize the display requirements for the hand-held devices.

Simple static web clipping pages stored on a server can be developed at little cost to an entity. The advantage of the simple static page is that it can relay information instantly since it usually takes so little time to load. Thus, if the user of a hand-held device wanted information on a nearby restaurant, then location, menu and reservation information could be loaded quickly onto the hand-held device. Although such pages provide a solution to the data transfer and the graphics problem, many entities do not consider developing a separate web clipping page (although they might as they cost less than $100 to develop) for hand-held and such pages can provide only the most basic information, usually in a text format.

Web clippings or web pages returned from a server are small, dynamically generated Web pages created by a common gateway interface (herein referred to as “CGI”) script. Web clipping can also be a static page stored on an Internet server. The page size (the amount of data exchanged) is the important factor to consider. Currently, the web clippings sent back can be less than 350 bytes in size, which is miniscule when considering the amount of data transferring from the Internet to a PC in a typical transaction.

Web clipping is usually written in HTML tags, but can also be written in other languages which may be used to present information over the Internet, such as XML, and Perl. JAVA is not particularly useful for web clipping because JAVA a great deal of computing power, although JAVA is often used. The notable differences between standard HTML and web clipping applications, (“.PQAs”), are that web clipping code does not support the following:

Names typefaces

Style sheets

Image maps

frames

Nested tables

Scripts and applets

Cookies

Devices are not available in web clipping either. What is permitted is simple tables, gray-scale color, limited font markup, list and images (limited).

Web clipping uses other custom tags to indicate changes in to the standard HTML page. Some examples are of <historylisttext> which stores queries to a PQA server so that repeat queries do not have to be made and the <localicon> which instructs a compiler to include the specified icon graphic on the compiled file. Icons can be particularly troublesome, because even small icons can take up a significant amount of memory on the data transfer.

An example of bow web clipping eliminates images and graphics that may overburden the graphics processor of a PDA is by using the command <smallscreenignore>. which allows the same HTML code to work with regular HTML or web clipping application. The <smallscreenignore> command simply blocks off extraneous images or codes with this tag.

Web clipping is relatively simple to execute, but requires that a developer take the time to develop an application for a particular Internet site. As stated above, many entities simply cannot afford the resources to make extra Internet sites for hand-held users or to develop the proper tools.

Another hand-held PDA, the OmniSky can run any Web Clipping or TCP/IP Palm application, while the Palm VII can only run Web Clipping applications. Making a Web Clipping application is relatively easy, a web page is created using a subset of HTML, then compiled from the static front page while all the graphics are loaded into a .pqa file. Implementing a web clipping application requires almost no learning curve for the developer, thus, there are lots of web clipping applications currently available.

Palm has recently developed hand-held devices that add color to the display. The problem with color on a hand-held display is that such hand-held devices usually have only 8-16 MB on memory at the maximum and such color displays would take up a huge amount of the allocated bandwidth in a transfer of data.

Other applications developed by entities using the Palm platform have been able to provide a greater degree of graphical complexity regarding wireless Internet browsing. However, data transfer is at a premium when using a wireless device because of the narrower available bandwidth.

Other companies have attempted to simplify the process of web surfing on hand-held devices with other methods. For instance, Bango.net of the UK, has developed a process in which a cellphone microbrowser can be navigated by entering numbers on the keypad. While this process would be convenient for people who have a few number correlated to Internet sites memorized or stored in memory, it is not very convenient for persons who are trying to look for unknown Internet sites.

Another alternative to web clipping has been alternate markup languages suited to the display requirements of hand-held devices. HDML stands for handheld device markup language. HDML is a cousin to HTML, the ubiquitous formatting language of the World Wide Web. HDML delivers a barebones, textonly version of Web content that is better suited to wireless devices, which typically have small screens and receive data at only 19.2 kbps. Handheld devices are characterized primarily by a limited display size. A typical display is capable of displaying 4-10 lines of text 12-20 characters wide and may be graphical (bitmapped) or text-only. PDA-style displays are not necessarily included in this handheld device category, although HDML will be useful on those devices as well.

Handheld devices may or may not have a full keyboard and may or may not have a pointing/selection device. HDML is programmed for use on devices with limited input mechanisms. As an example, the data-ready mobile phone has only:
the keys normally found on a telephone (0/9, *, #, with alphabet letters marked on 29)
cursor/arrow keys (often just up and down or left and right)
a number of dedicated function keys (SEND, END, etc.)
one or more “soft keys” with programmable labels s.

Combining the use of standard web protocols and infrastructure (URLs, HTTP, SSL plus CGI, Perl, commercial, web servers) with an alternate but complementary markup language, allows handheld devices to function as full-fledged web clients. Like many languages, HDML requires a run-time environment to make it useful. The element that provides the run-time environment for HDML is referred to as the user agent. The fundamental building block of HDML content is the card. The user agent displays and allows the user to interact with cards of information. Logically, a user navigates through a series of HDML cards, reviews the contents of each, enters requested information, makes choices, and moves on to another or returns to a previously visited card.

Cards come in one of four forms: No display, display, choice, and entry. Display, choice, and entry cards contain text and/or references to images that are displayed to the user. Choice cards allow the user to pick from a list of available options, and entry cards allow the user to enter text. While it is expected that cards contain short pieces of information, they might contain more information than can be displayed in one screen full. The user agent will provide a mechanism for the user to view the entire contents of the card. An example of this would be a user-interface that allows scrolling through the information.

Although HDML is a useful way to get content displayed on a hand-held device and may even provide for easier navigation, a programmer must code in both HTML and HDML to get wireless content out. Such additional programming can be very expensive and require specialists to learn a new web programming language. Internet design and programming companies promote their HDML capabilities to attract business who want both PC and hand-held based web services.

Another negative aspect of wireless browsing is the amount that data transfer costs. One negative aspect of the Palm wireless devices is that Palm Wireless, the division that supports the wireless services to the wireless hand-held devices, charges by the amount of data that is transferred. So a typical graphic display of 50K would use up a month's worth of data or cost $15.00 to load one Internet graphic. Generally, the costs of this wireless device is from $10 a month for 50 KB, up to unlimited data transfer for $44.95 a month. The price of the transfer of data to wireless devices may come down as the devices become more prevalent and competitors start offering services.

The physical act of navigating on a wireless device is also a challenge. The pen operated Palm devices require that a user often have both hands in use (one for the pen, one for the device) while navigating. The user touches the pen 26 to highlighted portions of the display screen 28 in order to simulate the act of “clicking” on a link. If a non web clipping page loads that is bigger than the PDA screen, the display 28 adds scroll bars which the user can touch to scroll the screen either horizontally or vertically. The problem with most of the PDA display scroll bar is that in order to maximize screen space, the scroll bar are one or two pixels wide and quite difficult to navigate with the pen 26. The use of the touch pen is more is more ergonomically cumbersome than the one handed use of a PC mouse used to navigate. Although some hand-held computing screens will present the 640×480 format, most hand-held users have much smaller and more “vertical” formats. For example, using the Palm as a newspaper constantly requires a user to scroll down because of the limited screen size.

Furthermore, navigation on a cell phone browser can be difficult because the small direction keys located on the keypad are difficult. Also the combination problem of “clicking” links and scrolling at the same time on the cell phone present usability problems for the user.

Because applications can be loaded onto the PDA and controlled by the internal system, applications such as text, calendar, phone lists, etc. for the PDA can be designed considering the PDA display limitations. Rich wireless content, however, does not have the PDA or cellphone in mind, and therefore the display limitations and potential solutions are especially relevant when considering content that is not specifically designed for the portable device. Therefore new navigation and scrolling techniques are especially relevant to wireless content.

Current solutions to hand-held displays of wireless content such as web clipping and cellphone microbrowsing are only appropriate for the most basic graphic displays and are not configured for control and browsing and navigating that is easy to use. What is needed is a computer network content conversion system for device displays that provides a higher quality of graphic content from the Internet or other computer network. The content should be designed to allow a user to navigate the display on a hand-held device intuitively because of the advantages intuitive navigation has over the cumbersome existing methods of web navigation on hand-held devices. What is also needed is a way to take advantage of the capabilities of the intuitive navigation system without taxing the memory capabilities of the hand-held devices, by designing display screens that use less resources.

### SUMMARY OF THE INVENTION

An obvious solution to the problem of hand-held wireless device navigation is natural motion controlled (herein referred to a “intuitively controlled”) display devices which load display frames appropriate for such navigating and scrolling control techniques. These frames are converted from standard rich content wireless networks and converted to take advantage of the unique navigating and scrolling techniques.

A solution to viewing and navigating on a small screen is the a system which allows for hand motion to control the viewing on a hand-held electronic device screen. This system teaches a portable visual display device which can be controlled by the movements of the device by the head or the hand, but particularly for handheld devices in a preferred embodiment. Originally, this technology was developed to assist low-vision users and in the fields of immersive virtual reality devices, but the technology has spread to the wearable and portable display devices. Intuitively-controlled displays have many advantages over conventional display technology with regard to devices which cannot display an entire display screen because of their limited size. Also devices that are portable should not require the use of both hands to navigate and scroll content.

However, in order to take advantage of intuitive motion controlled display system, a system will need to take standard wireless and network content pre-arranged display frame variants which take advantage of intuitive controlled displays, like evenly split screens or screens with enhanced edges or centers can be loaded into the hand-held buffer memory and will provide a fast alternative to the clumsy web clipping frame loading systems now available for hand-held devices.

In order to provide hand-held computer displays with a full range of rich graphic content, the present invention provides a method and system to convert rich graphic content to be converted to an intuitively controlled display system for hand-held devices and devices which display data in a virtual reality-mimicking setting on a hand-held level.

An embodiment of the invention includes means for loading standard images from the Internet of other computer network, means for converting the images to screens which are appropriate for intuitively controlled hand-held devices, and the means for sending the converted screens to wireless devices.

The invention includes several alternate embodiments which converted the frames according to the display requirements (e.g. screen size, type of device, etc.) and the display preferences (e.g. orientation, scaling, color, etc.) of the devices and users. The invention also include features which take advantage of the intuitively controlled system to set up individual screens so that they more easily be navigated by the intuitively controlled devices during Internet browsing.

These and other advantages of the present invention will become apparent upon reading the following detailed descriptions and studying the various figures of the drawings.

### BRIEF DESCRIPTION OF THE DRAWINGS

FIG. 1A is prior art diagram of a typical screen of a computer monitor.

FIG. 1B is the prior art diagram of a typical raster display and a block diagram of the hardware components of the virtual computer monitor.

FIG. 2 is an exemplary prior art PDA display screen.

FIG. 3A illustrates the prior art problem of scaling a full display screen to a PDA display screen.

FIG. 3B illustrates the prior art problem of shaping of a typical computer display screen to display on a PDA screen.

FIG. 4 is an exemplary prior art cellphone display screen.

FIG. 5 is a prior art flow diagram of web clipping.

FIG. 6 is a sample PDA screen with example content.

FIG. 7 is a sample PDA screen after a movement in the positive y-direction and movement in the positive z-direction.

FIG. 8 is a sample PDA screen in FIG. 7 after movement in the positive y-direction and the negative z direction.

FIG. 9 is a sample PDA screen with a movement indicator icon.

FIG. 10 is the PDA screen in 9 after movement in the negative x-direction.

FIG. 11 is the PDA screen in FIG. 9 after movement in the positive x-direction.

FIG. 12 is the PDA screen in FIG. 9 after movement in the negative z-direction.

FIG. 13 is the PDA screen in FIG. 9 after movement in the positive z-direction.

FIG. 14 is the PDA screen in FIG. 9 after movement in the positive y-direction.

FIG. 15 is the PDA screen in FIG. 9 after movement in the negative y-direction.

FIG. 16 is an illustration showing a PDA as in 9, wherein the PDA screen did not change during a sudden violent movement of the arm.

FIG. 17 is a flowchart showing a computer implemented method for responding to a user's hand movement.

FIG. 18 is a flowchart showing a method for discrete magnification in accordance with one aspect of the present invention.

FIG. 19 is a flowchart showing a method for discrete de-magnification in accordance with another aspect of the present invention.

FIG. 20 is a pictorial illustration showing several intuitive head gestures that correspond to special discrete functions;

FIG. 21 is a flow chart illustrating one computer implemented method for controlling a computer system with a head-mounted display device;

FIGS. 22-24 are flow charts illustrating methods for performing magnification and scrolling commands with intuitive head gestures;

FIG. 25 is a flow chart illustrating one method for controlling the correspondence between the displayed field of view and the user's head position;

FIG. 26 is a block diagram of the content conversion system as implemented.

FIG. 27 is a block diagram of the control converted controller system.

FIG. 28 is a further detailed block diagram of the content conversion system.

FIG. 29 is a block diagram on the display output frame.

FIG. 30 is a flow chart illustrating the process of content conversion.

FIG. 31A is a diagram of a simple display frame.

FIG. 31B is a diagram a frame quartered for hand-held display by a content conversion system.

FIG. 32A is a diagram of a simple display frame as shown on a computer screen.

FIG. 32B is the frame converted and shown on a hand-held PDA.

FIG. 32C is the frame in FIG. 32B stored in a buffer memory at enlargement with a movement in the positive Z-direction.

FIG. 32D is the frame in FIG. 32B stored in a buffer memory at enlargement with two movements in the positive Z-direction.

FIG. 33 is an example of frame conversion for a PDA by one color convolution method;

FIG. 34 is an example of frame conversion by a center-enhancement method.

FIG. 35 is an example of an alternate frame conversion by a shape convolution methods.

FIG. 36 is an example of “non ending” rollover screen.

FIG. 37 is the feature of the center-enhanced screen in FIG. 34 with the feature in two dimensions.

FIG. 38 is the feature of the edge-enhanced screen in FIG. 35 with the feature extended in two dimensions.

FIG. 39 is the feature of the rollover screen of FIG. 36 in two dimensions.

FIG. 40A-D are examples of a frame conversion method for an immersive environment device (hand-held).

FIG. 41 is a block diagram of the display customization system.

FIG. 42 is a method for customizing a frame for an intuitively controlled handheld display.

FIG. 43 is an example of a orientation display shift.

FIG. 44A is an example of scaling.

FIG. 44B is a diagram of resulting frame transformation due to scaling.

FIGS. 45A-E is an example of resulting frame shift by the preference system.

FIGS. 46A-G illustrates a preferred embodiment in which the screen is divided into regions, in which only one of the regions responds to special discrete commands.

FIG. 47 illustrates the process by which the preferred embodiments may be implemented.

FIGS. 48A-D illustrates a preferred embodiment in which special discrete commands control the highlighting of links and the navigation of the microbrowser.

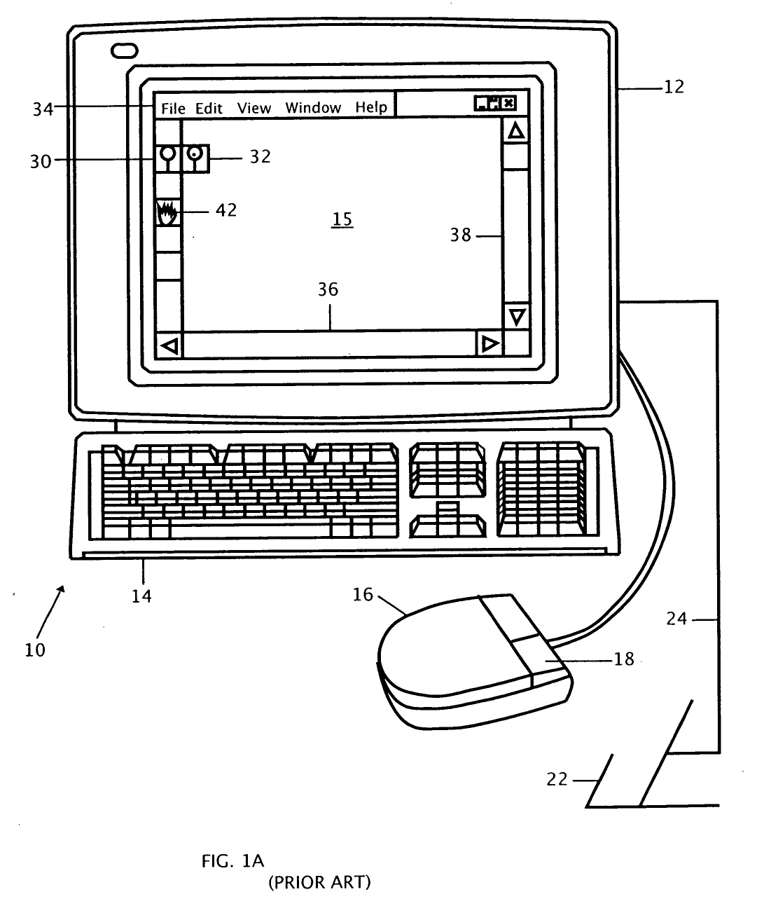

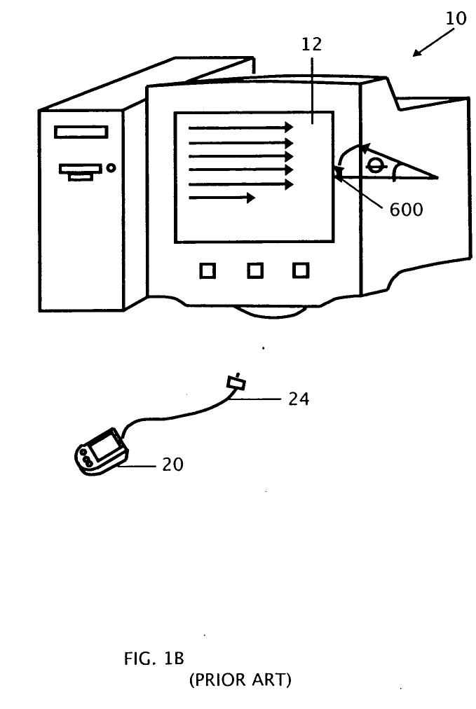

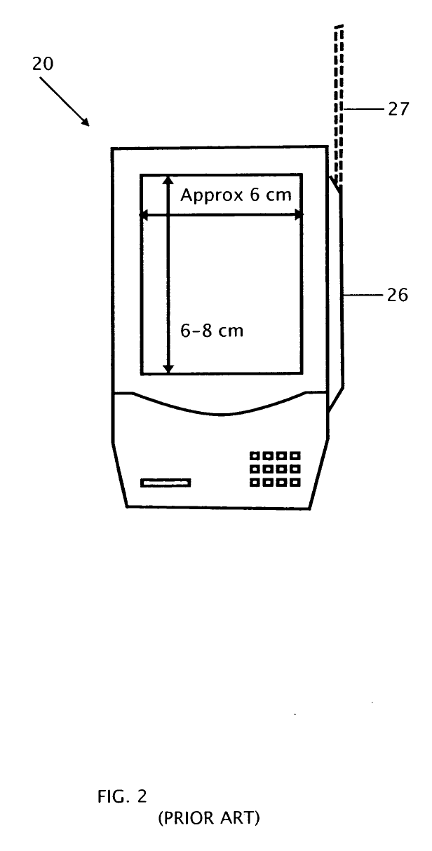

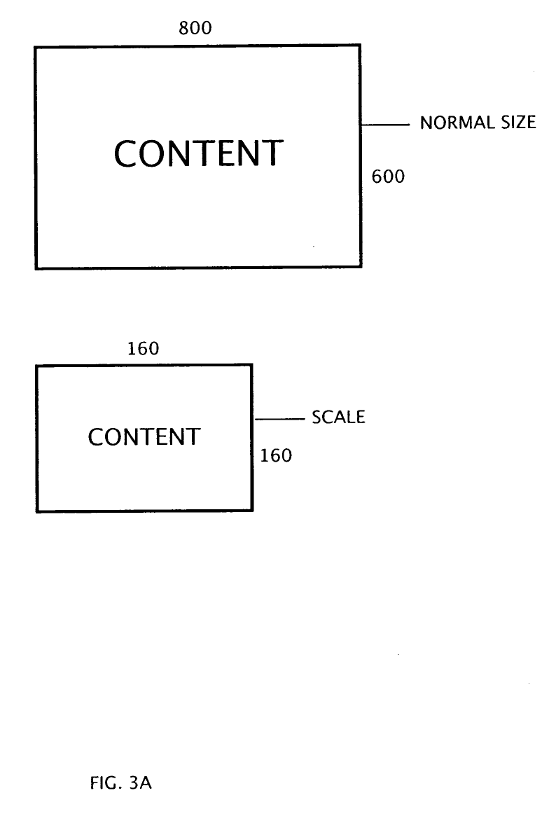

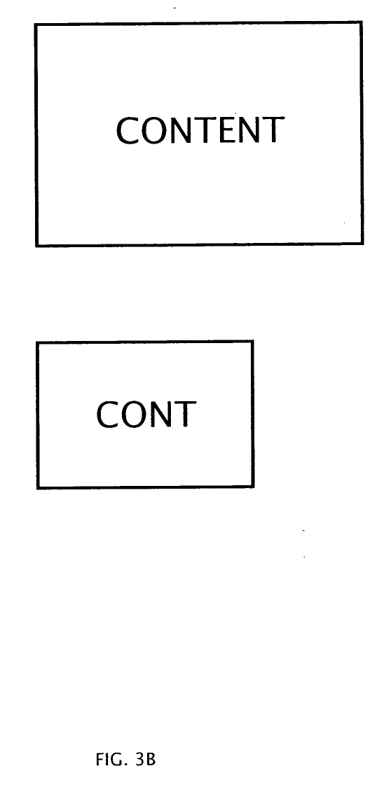

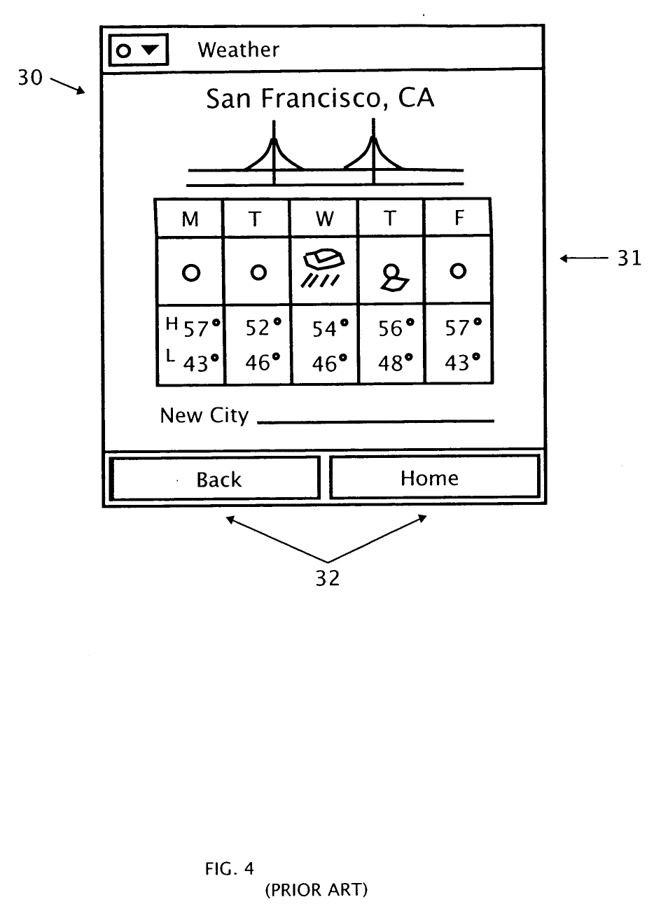

### DEFINITIONS USED IN THE DETAILED DESCRIPTION

In the following description of the invention, the following definitions are used:

A frame refers to a set of electronically displayable graphics, text, or pictures that can be displayed all at one discrete point in time on a display device. In the specification “frame” and “graphics” are used interchangeably, although “graphics” may refer to a subset or superset of frames. The contents of one computer screen is generally the definition best used in the specification.

The positive x-direction is movement to the right of the device user.
The negative x-direction is movement to the left of the device user.
The positive y-direction is upward movement.
The negative y-direction is downward movement.
The positive z-direction is movement towards an individual PDA user which in one embodiment of the invention causes the screen to perform a zoom in (magnify screen) operation.
The negative z-direction is movement away from an individual PDA user which in one embodiment of the invention causes the screen to perform a zoom out (reduce screen) operation.

A specific movement command is any movement of the intuitively controlled device by the hand of the PDA users, which results in movement of the screen.

The virtual desktop refers to any graphic representation of the contents of a computational device, usually a computer display screen with a graphic user interface.

A pixel as is appreciated by one skilled in the art, is the smallest unit of a which a display is comprised. A typical computer screen is 640 pixels by 480 pixels.

### DETAILED DESCRIPTION OF THE INVENTION

While the present invention has been described in terms of several preferred embodiments, there are many alterations, permutations, and equivalents which may fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

The present invention contemplates a variety of portable display devices operable to control a computer system through intuitive body gestures and natural movements. For example, a wrist worn display could be controlled by hand, wrist, and arm movements. This would allow functions such as pan, zoom, and scroll to be effected upon the wrist worn display. The wrist worn display could be coupled remotely with a central computer system controlled by the user through the wrist worn display. Alternatively, the wrist worn display itself could house a computer system controlled by the intuitive gestures. Additionally, the gesture tracking device could be separate from the wearable display device, allowing the user to attach the gesture tracking device and manipulate it as desired. Still further, the user may be provided multiple wearable control devices for controlling the computer system through intuitive body gestures.

A preferred embodiment of the present invention uses the concept that motion of a display device controls an object viewer, where the object being viewed is essentially stationary in virtual space in the plane surrounding the display device. Motion sensing of the display may be done by a variety of different approaches including mounting an accelerometer chip at an angle with respect to a circuit board and also by having an angled circuit board as will be described in greater detail. This can be applied to the hand-held situation mentioned above or for virtual reality devices in which the user wears a display, which is discussed below.

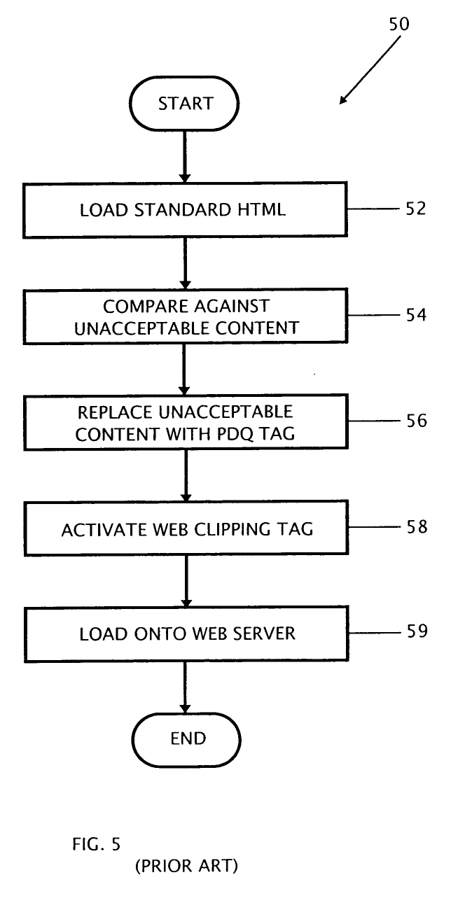

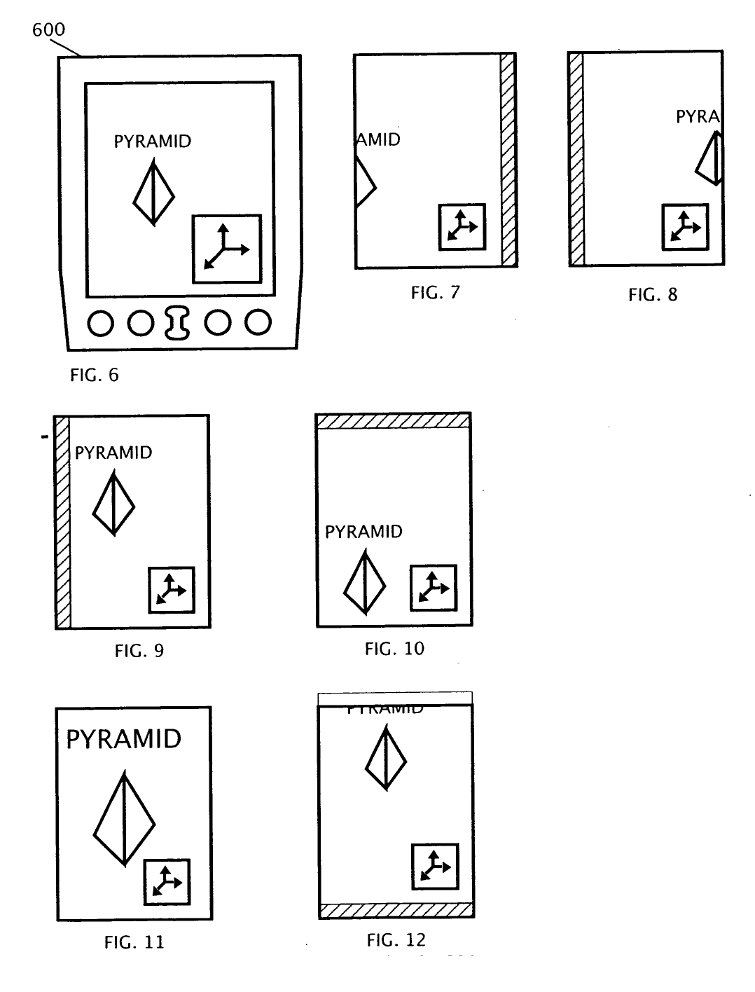

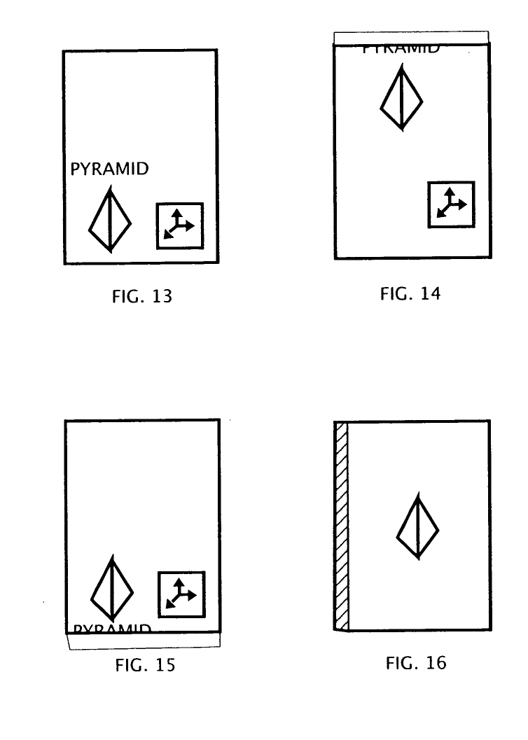

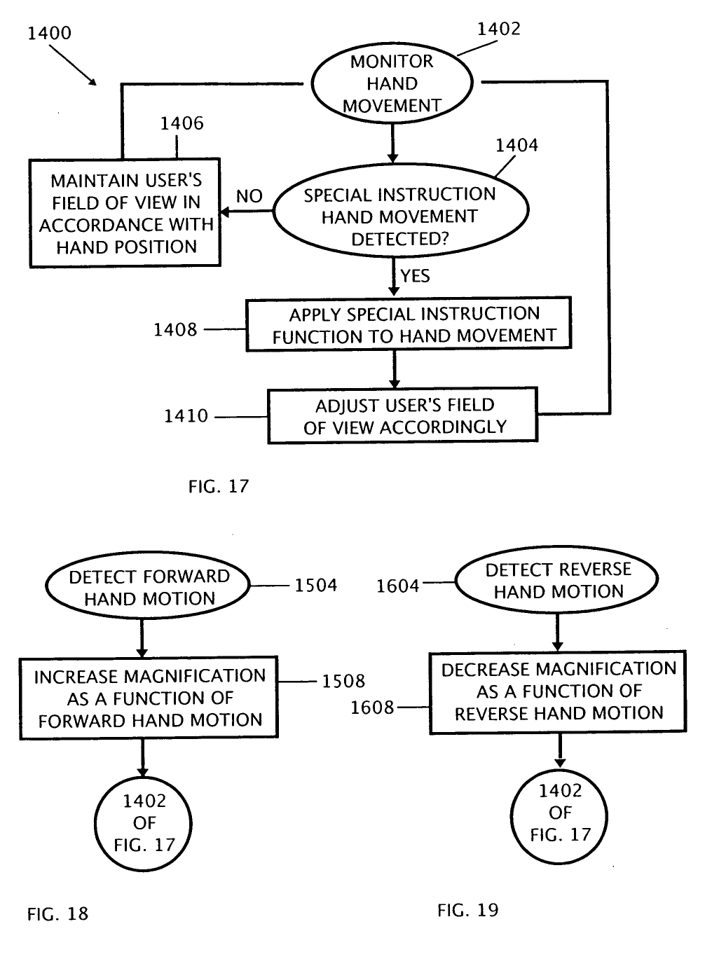

FIG. 6 demonstrates such a portable device operable to control a computer system through intuitive body gestures and natural movements in the form of a Personal Digital Assistant (PDA) 600. FIG. 7-16 are further illustrations showing operation by intuitive body gestures in 3-dimensions. Also included in FIG. 7-16 is a motion template 620 to be used hereafter to describe the user's control interaction.

Certain specific hand gestures that correspond in an intuitive manner as defined “special discrete commands.” A two tailed motion arrow in FIG. 6B-6K illustrates up and down hand motion along the x-axis, which could control document scrolling. For example, the user could begin rotating with a downward or upward motion to initiate downward or upward scrolling, respectively. Another two-tailed motion arrow indicates side-to-side hand motion along the y-axis. This side-to-side motion could bring about a panning action. The last two-tailed motion arrow 610 illustrates brisk or abrupt head shaking motion, which could cause erasure or screen clearing.

Turning to FIG. 7, one computer implemented method 700 for responding to a user's hand movement will now be described. A first step 702 represents monitoring the user's hand movement. Hence at step 702, the user is supplied a hand-portable display device which provides at least visual feedback. The computer system, through the display device, gyros and/or accelerometers has the capability to track the user's hand movement. Such a computer system is described above in more detail. Note that in preferred embodiments, the user's hand movement will be monitored in what may be considered for present purposes a continuous manner. In a next step 704, the computer system responds to sensed user hand movement by determining whether a special discrete command has been entered. If not, control is passed to a step 706, which updates the virtual space such that the user's field of view is maintained in accordance with the hand position.

In step 704, the computer system must distinguish special discrete commands from other hand movement simply not intended to adjust the user's field of view, such as small natural movements caused by the user's environment. This can be accomplished in step 706 through a variety of mechanisms. In some embodiments, certain hand gestures could be mapped to corresponding special discrete commands. These hand motions preferably are distinct from motions a user might be required to make to use the hand-mounted display. In other embodiments, a first hand gesture (e.g., a very abrupt rotation) could indicate to the computer system that the next hand motion is (or is not) a special discrete character. Thus the first hand gesture would operate like a control character, with subsequent hand gestures being special discrete commands.

In any event, when the computer system has ascertained in step 704 that a special discrete instruction has occurred, control is passed to a step 708. In step 708, the computer system applies a function associated with the special discrete command to the sensed hand motion. These functions can be based on hand position and all related derivatives (velocity, acceleration, etc.). These functions may also be piecewise, with discrete portions having varying response characteristics. Once such a function has been applied, control is passed to a step 710 wherein the user's display is adjusted accordingly. Once the display is adjusted, control is passed back to monitor hand movement step 702.

With reference to FIGS. 8 and 9 several example hand gestures and their corresponding special discrete commands will now be described. FIG. 8 illustrates the implementation of a discrete magnification instruction in accordance with one embodiment of the present invention. In a step 724 (a specific case of step 704 of FIG. 7), the computer system detects a forward hand motion intended to cause magnification. Control is thus passed to a step 728 (a specific case of step 708 of FIG. 7) where the magnification function is implemented. This function may increase magnification as a function of the change in user's hand position, the speed of the user's hand gesture, and/or the acceleration of the user's hand gesture. After the magnification has been adjusted, control is passed back to step 702 of FIG. 7. Steps 744 and 748 of FIG. 9 implement a process similar to that of FIG. 8, the difference being that the method of FIG. 9 applies to reverse hand motion and a corresponding decrease in magnification. When finished, control is passed back to step 702.

The described special discrete commands are currently well-known commands such as scrolling, page down, erase, etc. However, it is contemplated that the most robust control of a computer system through intuitively controlled display devices will expand to commands specific to such a computing environment.

In a preferred embodiment, the intuitive motion control of hand-held devices is applied to a wearable device, which uses many techniques in the field of virtual reality. Virtual reality is typically defined as a computer-generated three-dimensional environment providing the ability to navigate about the environment, turn one's head to look around the environment, and interact with simulated objects in the environment using a control peripheral.

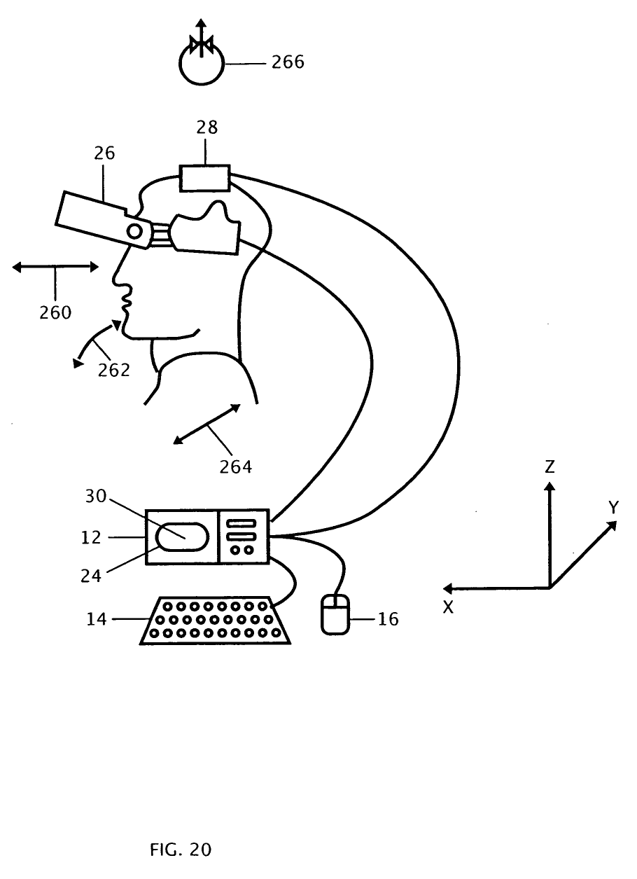

The present invention also teaches entry of computer control commands through intuitive head gestures in a virtual reality like environment. In other words, in addition to adjusting the user's field of view by tracking head motion, we define specific head gestures and correspond these specific head gestures in an intuitive manner with “special discrete commands.” FIG. 20 illustrates some possible head gestures that may be use. A two-tailed motion arrow 260 illustrates forward or backward head motion and such gestures may correspond to increasing or decreasing display magnification. A two-tailed motion arrow 262 illustrates head-nodding motion, which could control document scrolling. For example, the user could begin nodding with a downward or upward motion to initiate downward or upward scrolling, respectively. Another two-tailed motion arrow 264 indicates side-to-side head motion. This side-to-side motion could bring about a panning action. The last two tailed motion arrow 266 illustrates brisk or abrupt head shaking motion, which could cause erasure or screen clearing.

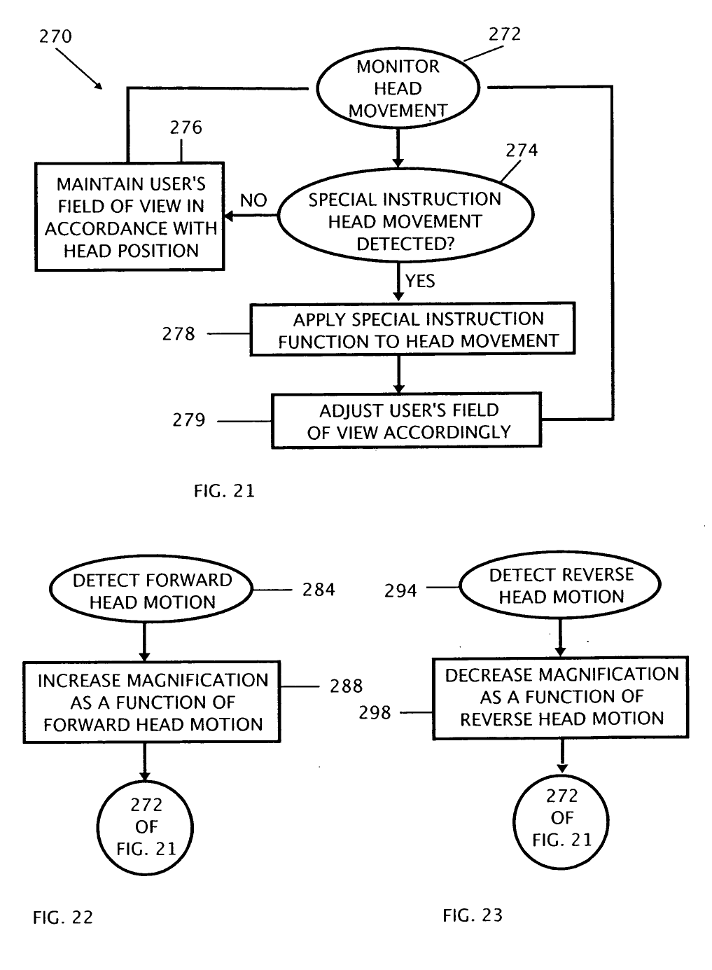

Turning to FIG. 21, one computer implemented method 270 for responding to a user's head movement will now be described. A first step 272 represents monitoring the user's head movement. Hence at step 272, the user is supplied a head-mounted display device which provides at least visual feedback. The computer system, through the display device e.g., has the capability to track the user's head movement. Such a computer system is described above in more detail. Note that in preferred embodiments, the user's head movement will be monitored in what may be considered for present purposes a continuous manner. In a next step 274, the computer system responds to sensed user head movement by determining whether a special discrete command has been entered. If not, control is passed to a step 276, which updates the virtual space such that the user's field of view is maintained in accordance with the head position.

In step 274, the computer system must distinguish special discrete commands from other head movement simply intended to adjust the user's field of view. This can be accomplished in step 276 through a variety of mechanisms. In some embodiments, certain head gestures could be mapped to corresponding special discrete commands. For specific examples, see the descriptions of FIG. 20 above, and FIGS. 22-24 below. These head motions ought to if possible be distinct from motions a user might be required to make to use the head-mounted display. In other embodiments, a first head gesture (e.g., a very abrupt nod or such) could indicate to the computer system that the next head motion is (or is not) a special discrete character. Thus the first head gesture would operate like a control character, with subsequent head gestures being special discrete commands.

In any event, when the computer system has ascertained in step 274 that a special discrete instruction has occurred, control is passed to a step 278. In step 278, the computer system applies a function associated with the special discrete command to the sensed head motion. These functions can be based on head position and all related derivatives (velocity, acceleration, etc.). These functions may also be piecewise, with discrete portions having varying response characteristics. Once such a function has been applied, control is passed to a step 279 wherein the user's display is adjusted accordingly. Once the display is adjusted, control is passed back to monitor head movement step 272.

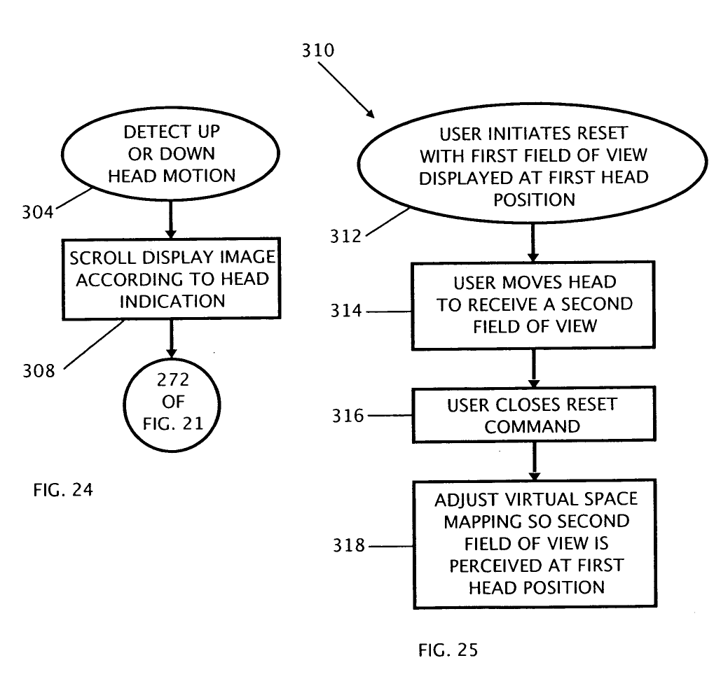

With reference to FIGS. 22-24 several example head gestures and their corresponding special discrete commands will now be described. FIG. 22 illustrates the implementation of a discrete magnification instruction in accordance with one embodiment of the present invention. In step 284 (a specific case of step 274 of FIG. 21), the computer system detects a forward head motion intended to cause magnification. Control is thus passed to a step 288 (a specific case of step 278 of FIG. 21) where the magnification function is implemented. This function may increase magnification as a function of the change in use's head position, the speed of the user's head gesture, and/or the acceleration of the user's head gesture. After the magnification has been adjusted, control is passed back to step 272 of FIG. 21. Steps 294 and 298 of FIG. 23 implement a process similar to that of FIG. 22, the difference being that the method of FIG. 23 applies to reverse head motion and a corresponding decrease in magnification. FIG. 24 illustrates a method for scrolling through the virtual display space. In a step 304, the computer system detects either up or down head motion defined as corresponding to special discrete scrolling commands. In response, in a step 308, the computer system scrolls through the virtual display space accordingly. When finished, control is passed back to step 272.

So far the described special discrete commands have been well-known commands such as scrolling, page down; erase, etc. However, it is contemplated that robust control of a computer system through a head mounted display device requires commands specific to such a computing environment. In particular, there should be a mechanism by which a user can adjust the correspondence between the displayed field of view and the user's head position. For instance, a user may wish to reset his “neutral” field of view display. Imagine a user, initially looking straight ahead at a first display, moving his head 30 or 40 in order to examine or work within this second field of view. It may sometimes make sense to examine this second field of view with the head cocked this way, but often it would be preferable to reset the field of view so that the user may perceive the second field of view while looking straight ahead. The present invention covers all mechanisms that would accomplish this reset feature.

With reference to FIG. 25, a method 310 for controlling the correspondence between the displayed field of view and the user's head position will now be described. In a first step 312, the user initiates a correspondence reset command. When this reset is initiated, the user will be in a first field of view with the user's head in a first head position. The computer preserves this information. In a next step 314, the user moves his head to a second position in order to perceive a second field of view. In a step 316, the user closes the reset command. In a final step 318, the computer system resets the virtual space mapping so that the second field of view is perceived at the user's first head position.

Note that the reset command may be initiated and closed by specific head gesture(s). Alternatively, the field of view could be coupled to the viewer's head position with a “weak force.” For example, the “weak force” could operate such that above a certain threshold speed, the displayed field of view would change in accordance with the user's head position. In contrast, when head movement was slower than the certain threshold speed, the field of view would remain constant but the user's head position would change.

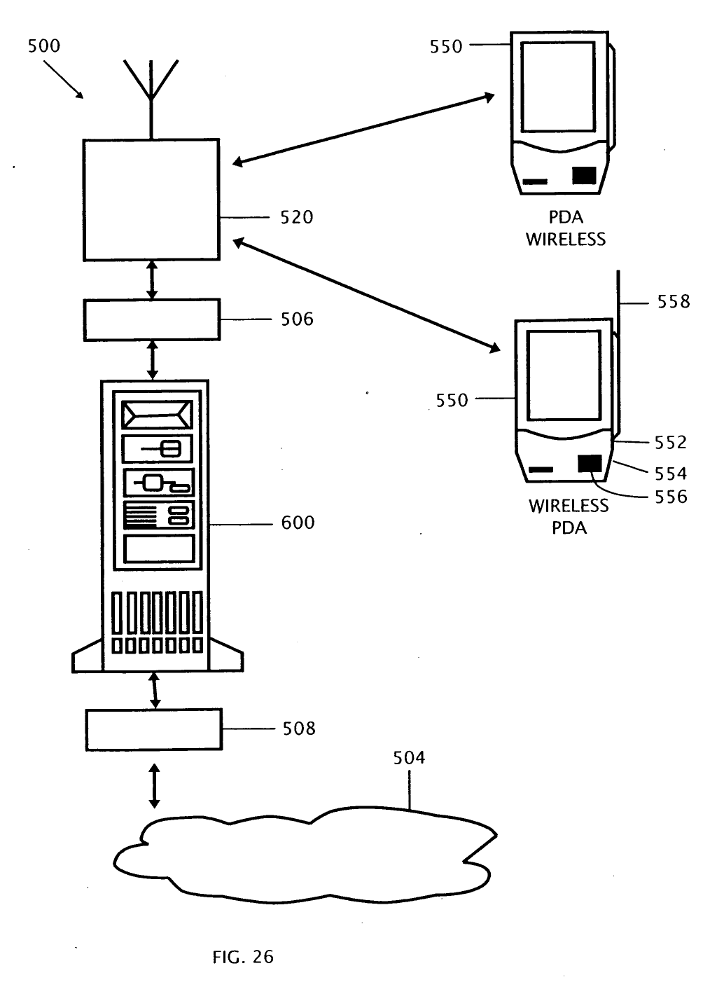

Referring now to FIG. 26, a content conversion system for hand-held display and head controlled wearable devices using a intuitive control display method 500 consisting of a target wireless hand-held device 550, a wireless broadcast and reception system 520, a first communications device 506, a second communications device 508, a computer network 504, and a computer system 600. The target wireless device contains a display 552, one or more control and activation buttons 554 and 556, and wireless antenna 558.

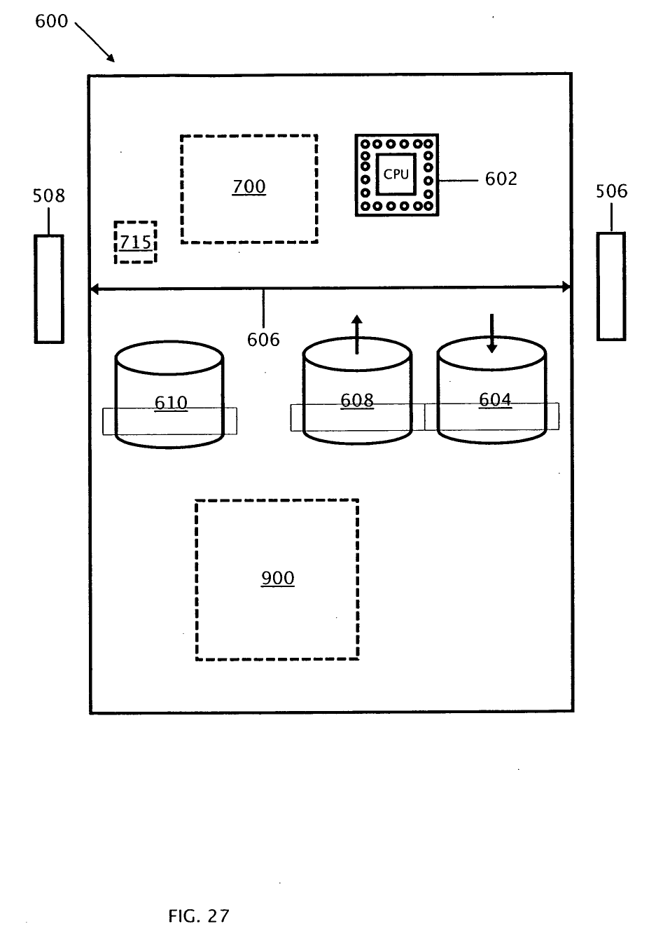

Referring now to FIG. 27, a further detailed computer system 600 used in the content conversion system 500 is shown. The computer 600 comprises a central processing unit 602, a input temporary storage 604, a data bus 606, an output temporary storage 608, a frame request storage 610, a frame request processor 715, and a frame conversion module 700, and a display preference module 900.

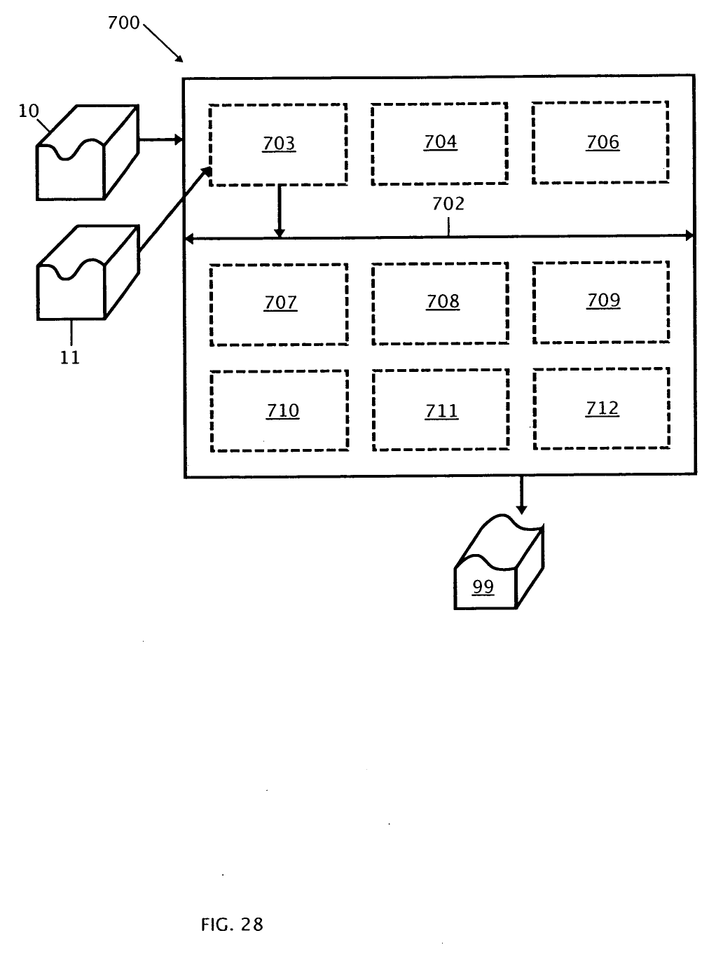

Referring now to FIG. 28 a frame conversion system for intuitively-controlled wireless device displays 700 is further detailed. The system 700 is comprised of a virtual data bus 702, a conversion control module 703, a color conversion module 704, a frame adjustment module 706, and A series of convolution modules 707-712, which will be described in detail later. The frame conversion module inputs a set of frame conversion instructions 11 and an input frame 10 and output an output frame 99.

Generally speaking, an input frame 10 will be loaded into the frame conversion module/system 700 from temporary frame request processor 715. The frame request processor will contain a series of instructions 11 that will activate the conversion control module 703 to activate the correct conversion modules. The input frame will pass through all of the activated conversion modules moving from one active module to the next via the virtual data bus 702. Each time the input frame 10 moves from one conversion module to the next, the data block containing the frame will be altered.

Module 704 will usually be active for all non color hand-held devices, as it will replace colors with appropriate gray-scale or two tone pixels which will be appropriate for the hand-held display. Also 24-bit color may be replaced with 16 or 256 color for simple color PDAs which have color, but not the memory to handle 24-bit color frames. As can be appreciated by those skilled in the art, the color convolution may take a number of different forms based on the type of display and the user preferences. Module 706 will generally convert the shape of the input frame 10, to one suitable for reviewing by intuitively controlled hand-held displays, There will be several ways by which the shape conversion may be appropriate, as there will be more that one type of display.

Modules 707-712 will convert the input frames according to various convolution methods based on the type of display device and the user preferences. One method on a small hand-held display will be to accentuate the center and diminish the edges in module 710. Other devices, most likely cellphone displays, may need the edges accentuated and the center diminished from module 711.

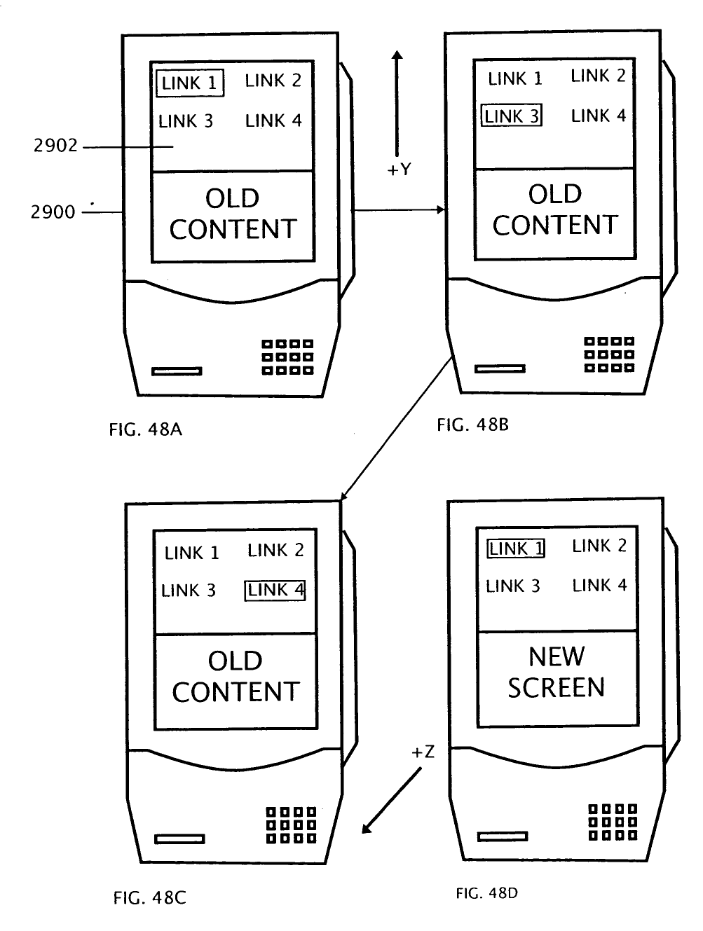

At least one conversion module 712 will replace the existing links in the input frame 10 that can be navigated by intuitive motions on the hand-held display. This conversion module will place a link within the frame 10 into a 2-D (rows and columns) pattern that can be displayed on the hand-held device and navigated using the intuitive movement system, The mechanics of this feature are discussed below and depicted by FIG. 48A-E.

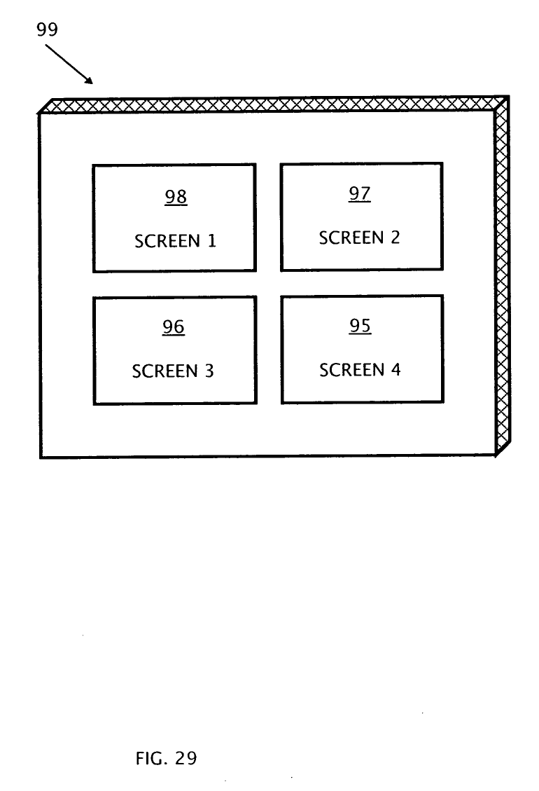

Conversion module 709 allows the frame to be split into easily navigable sections, such as 4 or 6 sections (3 frame width by 2 frame depth, for example) with each section stored in buffer memory, for the efficient use of the limited hand-held memory and without having to reload frames from the system 600. Therefore, the output frame 99 actually may contain many hand-held display screens, which can be stored in the memory of the PDA device 550 in order to maximize memory capacity. FIG. 29 illustrates a blow up of output frame 99 which may be comprised of several “screens” or subframes 98 to be send to the preference module 900 and ultimately the hand-held screen.

Other conversion modules 707 and 708 will prepare the input frame for various requirements of the hand-held device, which may include shape simplifying (module 707) and edge-enhancement module 708. Conversion techniques will be varied especially for those screen requirements which have display screens with unusual characteristics, like a circular display, immersive or 3-dimensional characteristics.

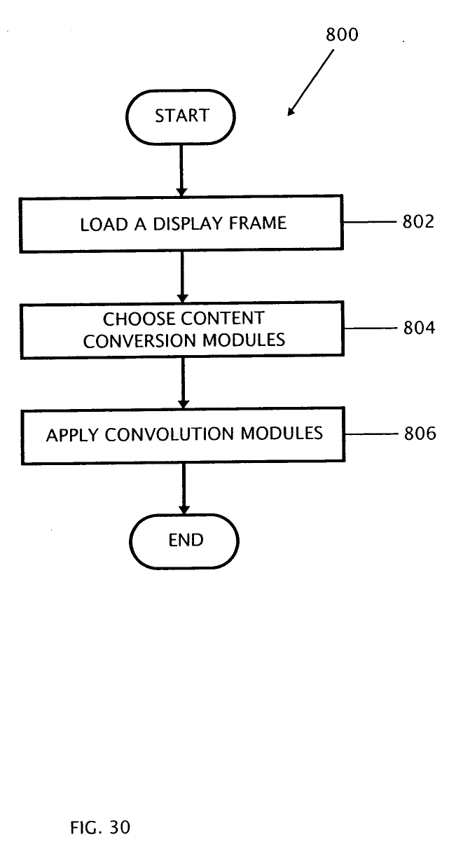

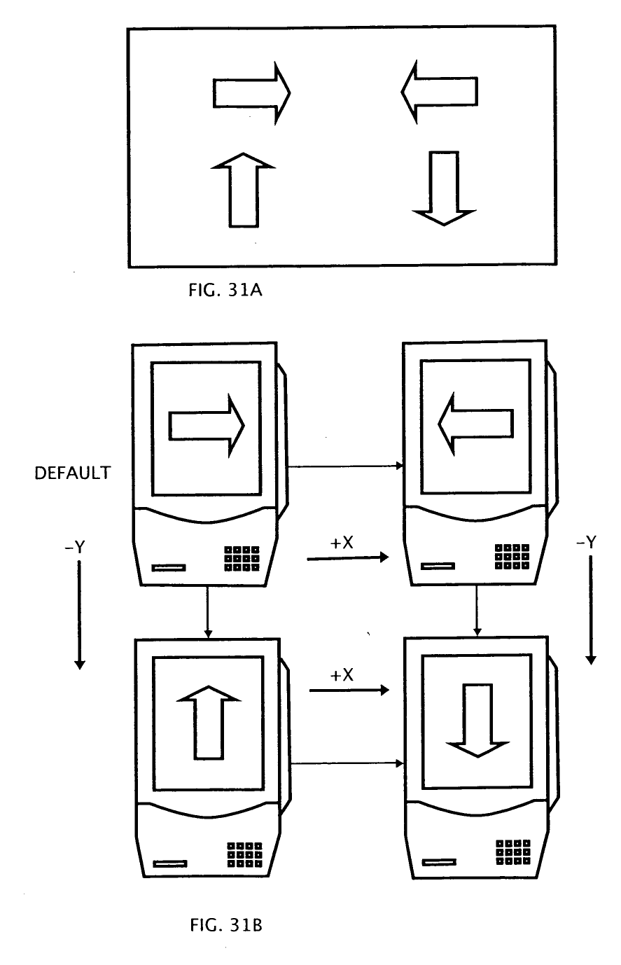

Referring now to FIG. 30, a display conversion method for intuitively controlled displays 800 is shown. In step 802, the module 700 loads a display frame 10 from input temporary storage 604. In step 804, the program chooses an appropriate frame transformation method based on the input display frame, the requirements of the output display frame, and the most economical method of transforming the frame. The most economical method of transformation a frame may be stored in memory for similar frame conversions. In step 806, the proper convolution method is applied to the frames based on the results of step 804. Practitioners skilled in the art of computer graphics will appreciate the number of ways that a single frame may be convoluted in order to meet the various output display frame requirements. For example, certain color shading may have to be changed to gray-scale shading in order to keep the integrity of the image.

In other cases, where the output display frame 99 requirements are for a display device 550 that is not rectangular, the output frame 99 may be convoluted in a fashion that the display frame 99 is magnified or demagnified at its edges. For example, some cell phones have display screens that are wider at the top than the bottom. In order maintain the integrity of a full screen image the display pixels at edges must be “squashed” horizontally.

Also, if a screen has one or more non-linear edges, it may require a minor adjustment of the screen in order to keep the characteristics of the original frame. One can easily envision a device with a round or elliptical screen that will require geometrical transformation algorithms in order to display the frame in a manner that is easily manipulated by the intuitive control system.

Furthermore, the intuitive controlled system lends itself to multiple graphical display options based on user preferences. Because the portable device screen is smaller than a typical personal computer display, users will have a variety of preferences as to how they wish to view their screens. For example, PDA users who use their screen to view stock quotes would be more interested in text and speed than actual graphics. The frame conversion method for such a user, may be to remove all unnecessary graphics and to split the screen into four, six or nine equal quadrants of text. This allows the user intuitively-controlled system to view each quadrant with a specific control motion. This type of frame conversion is represented by FIG. 31A and FIG. 31B.

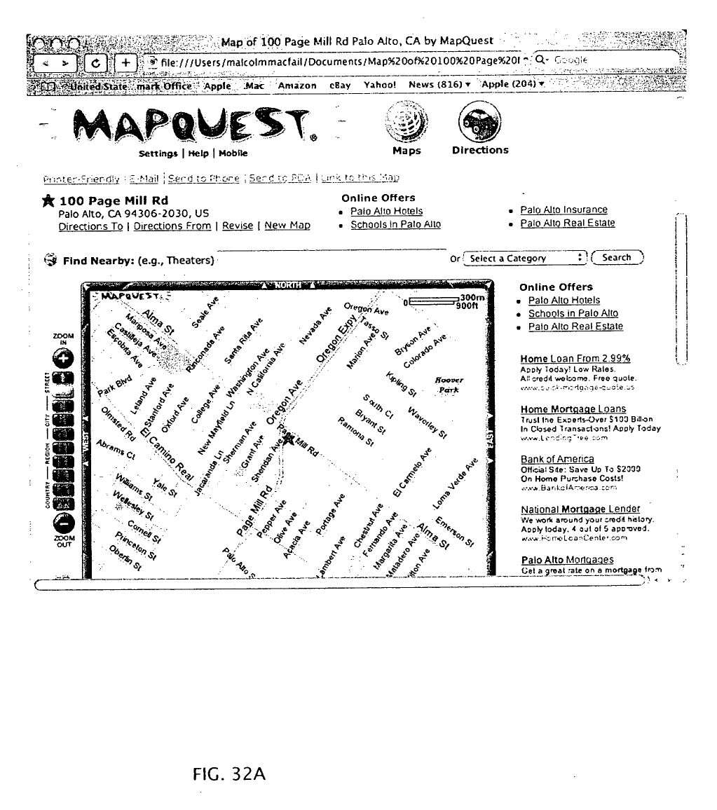

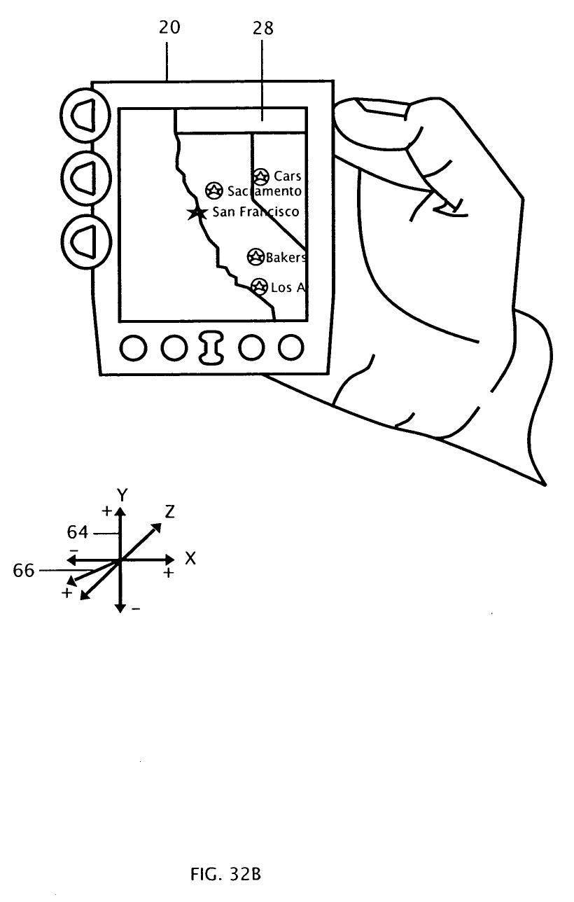

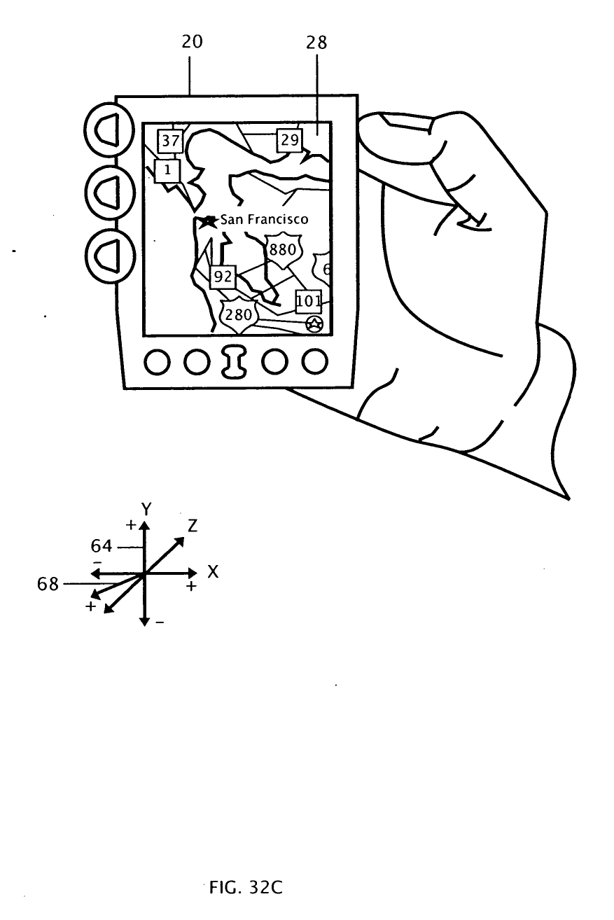

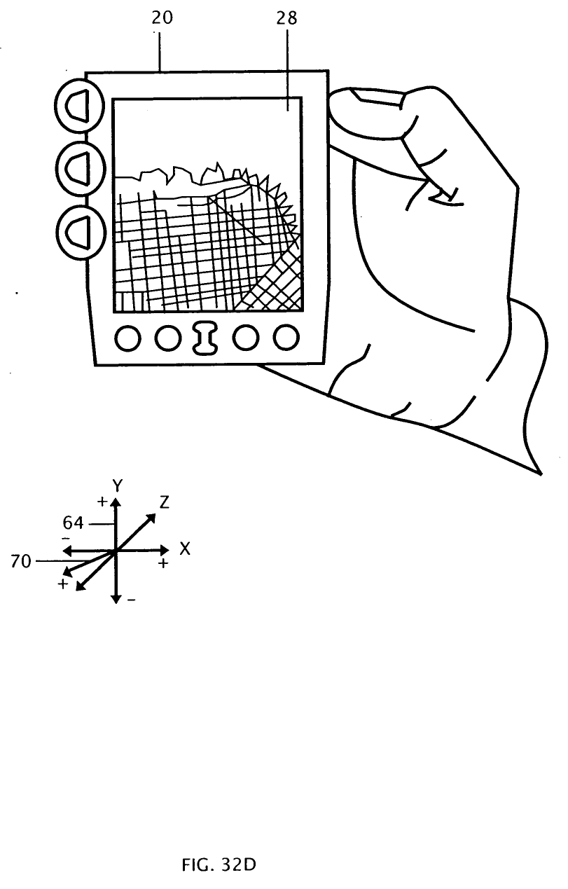

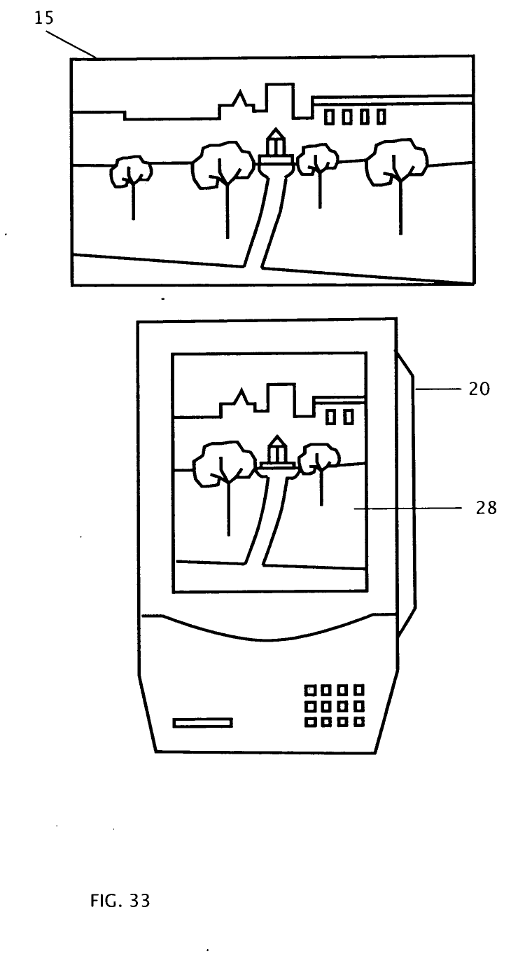

In contrast, perhaps another user, a salesman, uses her portable computer to download maps of her sales route while she is traveling. She would required much more fine detail for her intuitive controlled display and may need greater magnification right away. The intuitively controlled display is vital because she can use other hand for other tasks, such using her phone. The frame conversion for this target device will be different than the one detailed above as is represented by FIG. 32A and the conversion method described above. This frame conversion method would allow the salesman to magnify the map three times with three specific movements commands in the positive z-direction (towards herself), which are represented by FIGS. 32B, 32C and 32D respectively.

FIG. 33 represents another implementation of the conversion method for the conversion module 700 in which the color is removed from the frame 10 and the gray scale at one end of the frame is faded to give the impression that the picture displayed on the hand-held is the same dimensions, and the center enhanced.

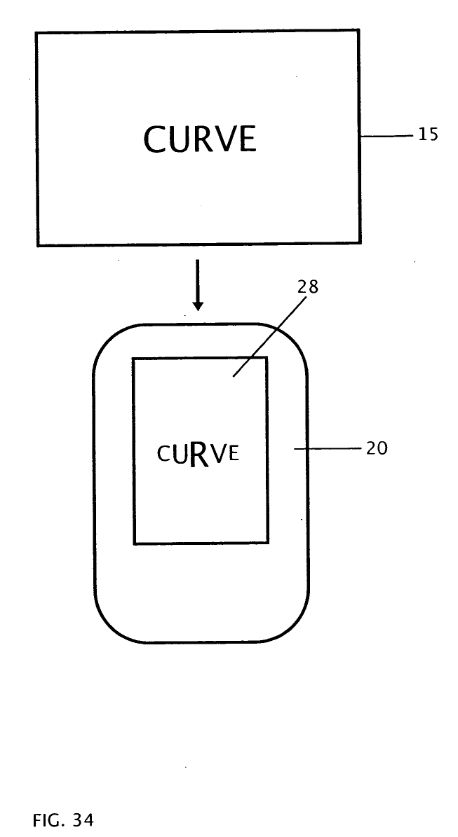

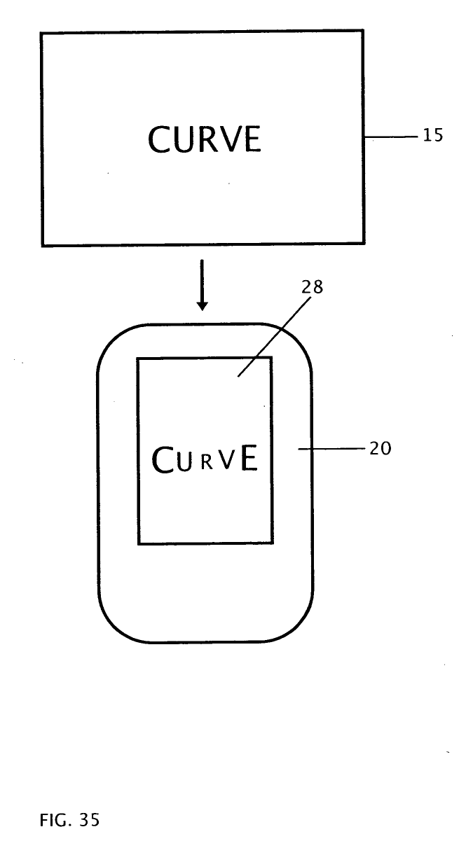

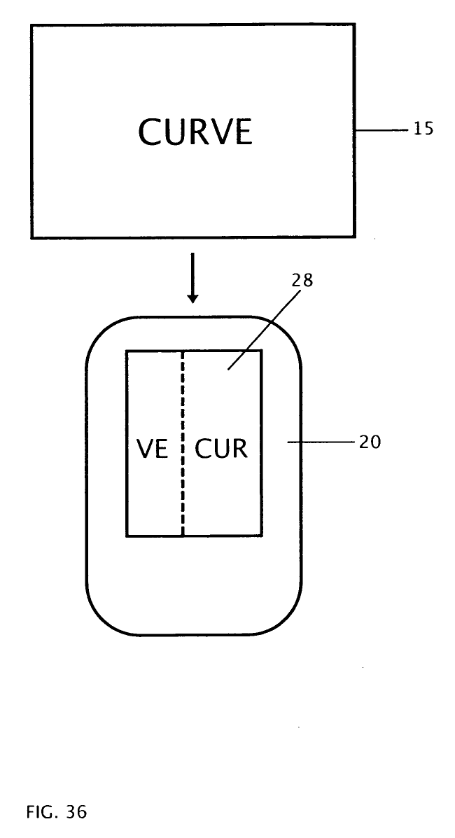

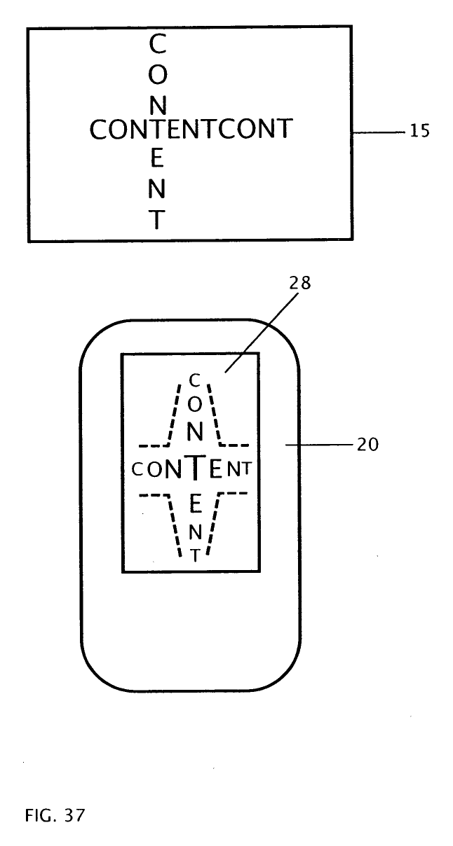

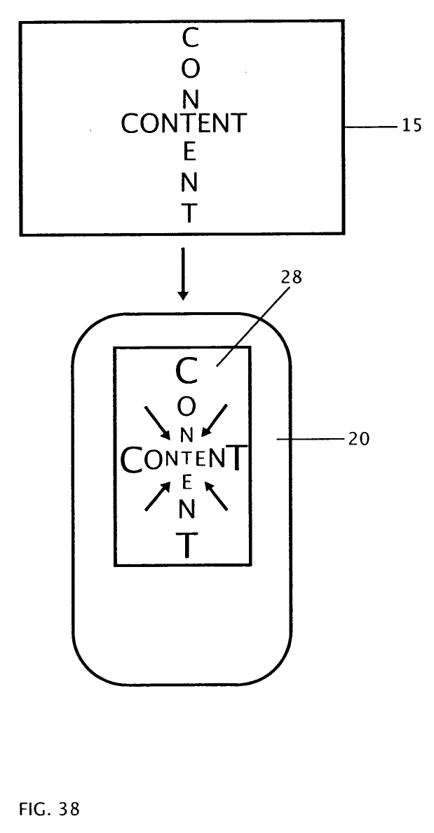

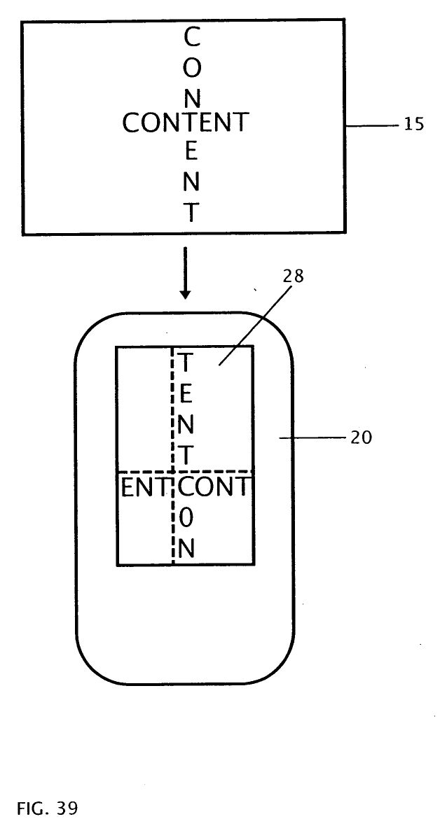

FIGS. 34-39 represent other possible ways for the frame 10 to be converted for a hand-held displays, including a rounded enhancement of the center (FIG. 34) to give a 3-D impression with the front at the center. Other variations convert the frame 10 to a 3-D) impression with the center behind the edges (FIG. 35), or continual scrolling screen (FIG. 36) in which there are no edges to the screen and the frame simply continues to wind around with the intuitive movements of the user. The process for creating this type of viewing screen is detailed below. FIGS. 37-39 details screens in which the same features are present in FIGS. 34-36, except that the features are implemented in 2 dimensions.

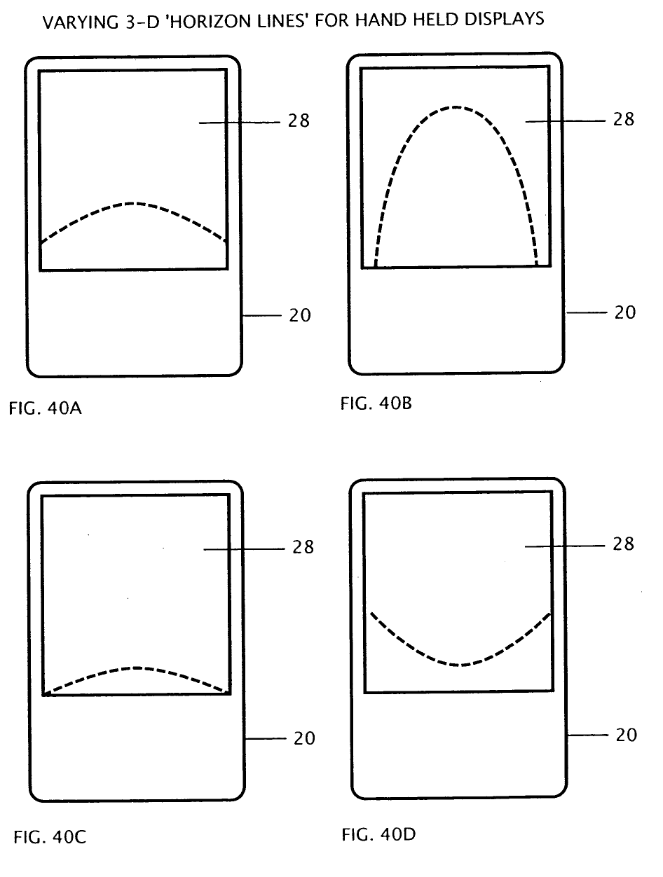

FIGS. 40A-D give another mariner in which the conversion for the hand-held devices can be implemented. In FIG. 40A the screen is converted to that of a 3-D immersive display device. This conversion is designed such that the hand-held device is used for viewing very close to the user's eyes, almost in the manner of goggles or a visor which can be worn. The screen is converted such that when a user looks very closely at the device the viewer gets virtually a 180 degree viewpoint and the horizontal axis at the center of the screen is at a distance compared to the edges, as if the user is “standing” the middle of the device looking at the frame. The immersive device conversion technique has many variations and will be expounded later in the specification. FIGS. 40B-D represent variations on the immersive screen conversion which may be practiced by the present invention.

As will be apparent to those skilled in the art, the implementation of the intuitively-controlled hand-held display will lend itself to many variations of the frame displays which are dependent on the target device display requirements and optional user preferences. It is also possible that any given frame will not require any conversion whatsoever to be effectively displayed on the target device display.

In a preferred embodiment, the frame conversion system 700 stores a history of user preferences based on past frame conversions. If the system 700 receives a request from a device and the temporary frame request processor 715 does not specifically pass instructions to change the frame requirements the of the output frame 99, then the frame conversion system will fall back to a default output frame.

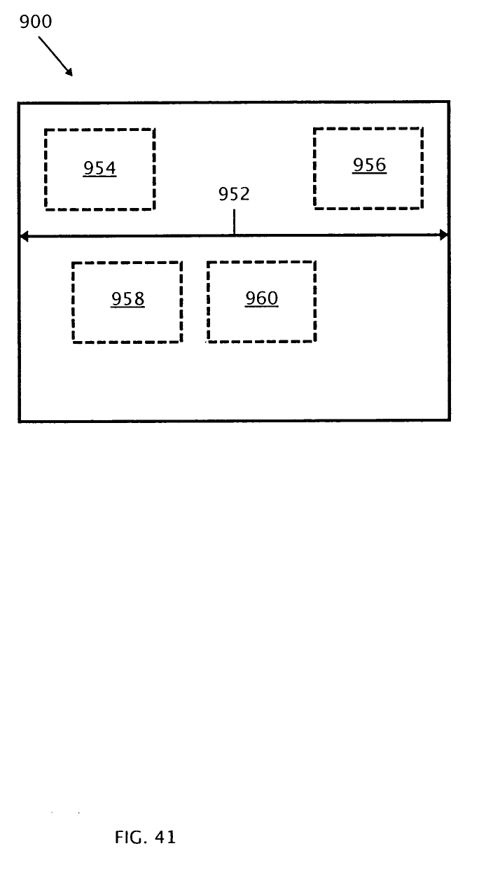

Referring now to FIG. 41, showing an optional feature of the present invention, a display preference system 900 consists of a virtual data bus 952, an orientation module 954, a scaling module 956, a placement module 958, and a color module 960.

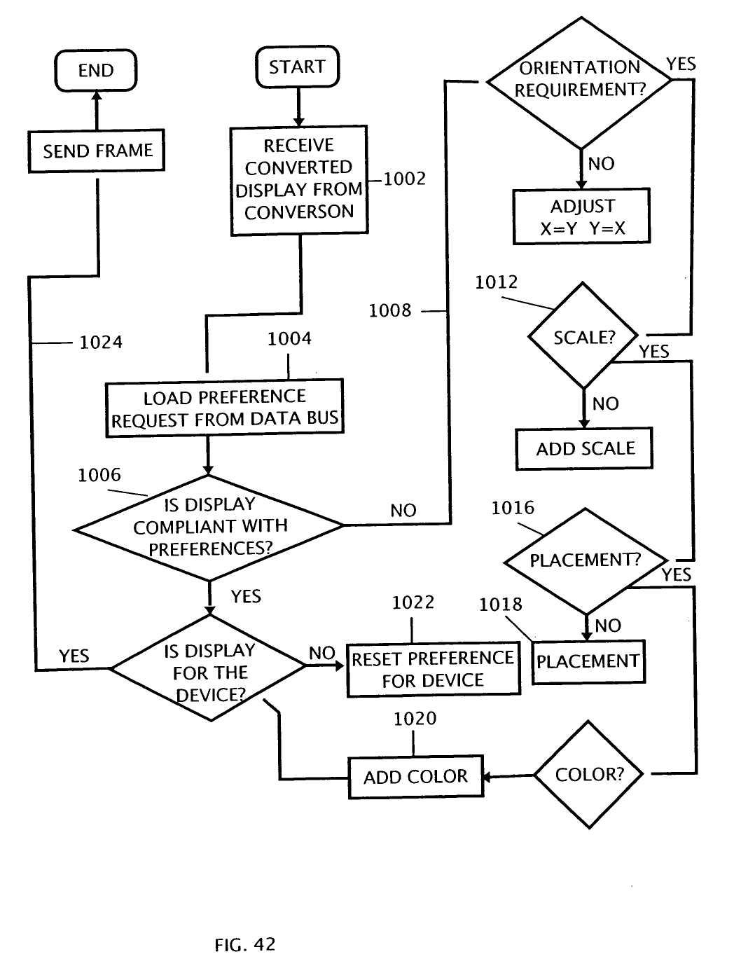

Referring now to FIG. 42 another optional feature of the invention is a method for adjusting a converted display to a set of user preferences 1000. The method downloads a frame from the data bus 606 in step 1002, and in step 1004 a preference request is loaded from output temporary storage 608 via the data bus 606. In step 1006 the frame parameters are compared to the preference request. If the parameters match, a check is done to see if the frames will be compatible with the device in step 1024, in case a user has more than one device such as a cell phone and a PDA with which they access the system 500. For example a user may have a PDA with which they browse, graphic based content, but they also may have a cellphone microbrowser with which only text based screens are appropriate. The cellphone would contain much less RAM and screen space than the PDA 550.

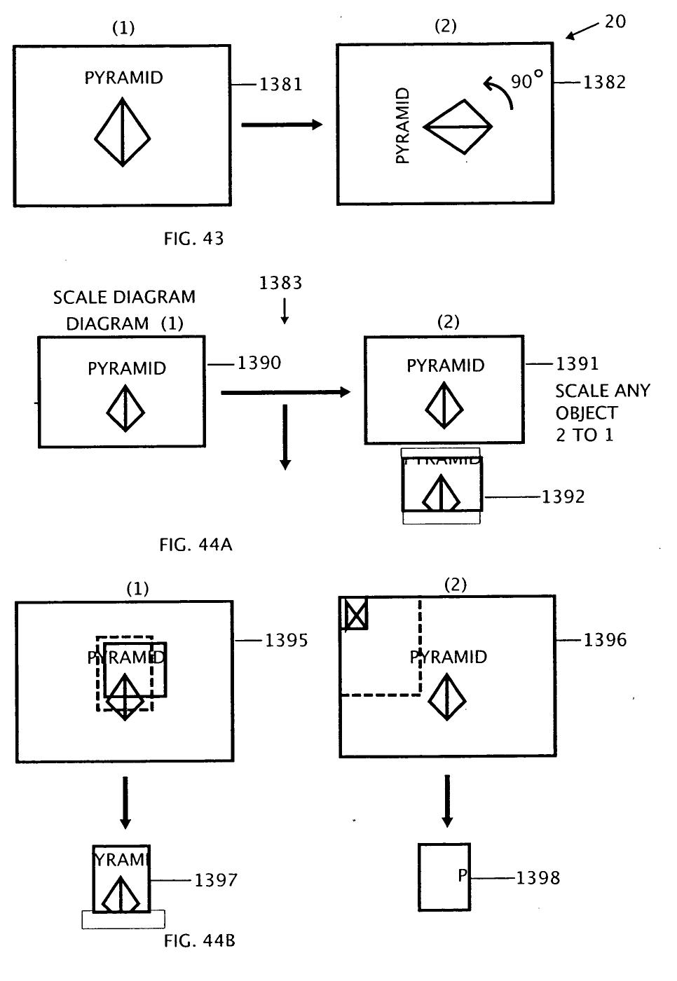

If the display requirements must be changed to meet the preference requirements in step 1008, the frame is checked for orientation requirements. This is usually a two state decision: orientation is either landscape or upright. However, one could easily understand that other orientations could be desirable on a small display screen, based on user preferences. If the orientation is correct, then the program skips to step 1012. If it is not compliant with orientation requirements, then the frame is reoriented. In a most simple format, that means the x values from 1 to 640 replace the y-values and vice versa. FIG. 43 represents a sample shift in orientation.

In step 1012, the program compares the scale preferences to the frames scale, if it meets the display request then the program moves to step 1016. If the scale requirements are not met, the computer program changes the scale of the frame to fit the requirements. Scaling is well known to those skilled in the art and is represented by FIGS. 44A-B which represents a sample shift in scale on a display frame.

In step 1018, the program compares placement preferences with the frame. In most instances the frame will be sent to the broadcaster server as a center default frame. If the frame is compliant with the display results standards then it jumps to step 1020. If the placement must be reset, the display locus is set to the appropriate location on the screen in step 1022.

A similar procedure is performed for color preferences in step 1020. Of course as detailed above in the convolution method, the display frame may have had to undergo substantial color changes in terms of gray scale, shading etc., but the user. If the frames match the color display requirements of the request, then the program jumps to step 1024.

TABLE 1
Intuitively controlled viewer request

| Segment | 1 | 2 | 3 | 4 | 5 |
|---|---|---|---|---|---|
| Control | Orientation | Scale | Placement | Color | Device |

TABLE 2A

| Bit setting | Orientation |
|---|---|
| 00 | Vertical |
| 01 | Horizontal |

TABLE 2B
Scaling

| Bit setting | Scale |
|---|---|
| 000 | 10% |
| 001 | 25% |
| 010 | 50 |
| 011 | 75 |
| 100 | 100 |
| 101 | 125 |
| 110 | 175 |
| 111 | 200 |

TABLE 2C
POSITIONING

| Bit setting | Position |
|---|---|
| 000 | Center |
| 001 | Upper left |
| 010 | Center left |
| 011 | Lower left |
| 100 | Upper right |
| 101 | Center right |
| 110 | Lower right |
| 111 | Uppercenter |

This system may be used or a more detailed system may be used which directs the placement of the display at a particular spot on the 160×160 pixel display.

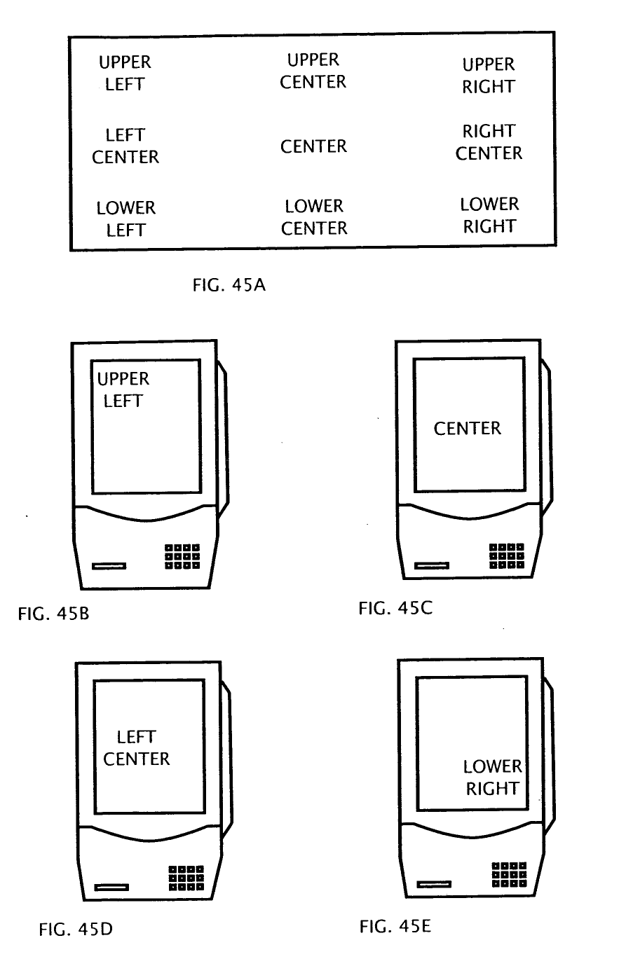

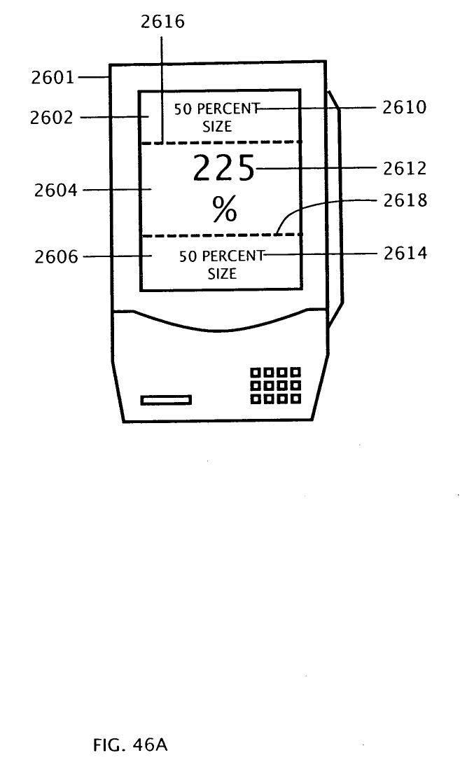

FIGS. 45A-E depict another feature of the invention in which the user preference system 900 aligns a display screen for the PDA according a user preference. FIG. 45A depicts an example frame from a computer, and FIGS. 45B-E illustrate the various positions that the resulting portion of the PDA screen may be placed. Certainly, the intuitive navigation of hand-held devices will result in a preference for a starting position on any screen. For example, a left handed user may prefer that the screen start on the lower right as opposed to the upper left as depicted in FIG. 45E. Other users may prefer to keep the screen starting in center as shown in FIG. 45C.

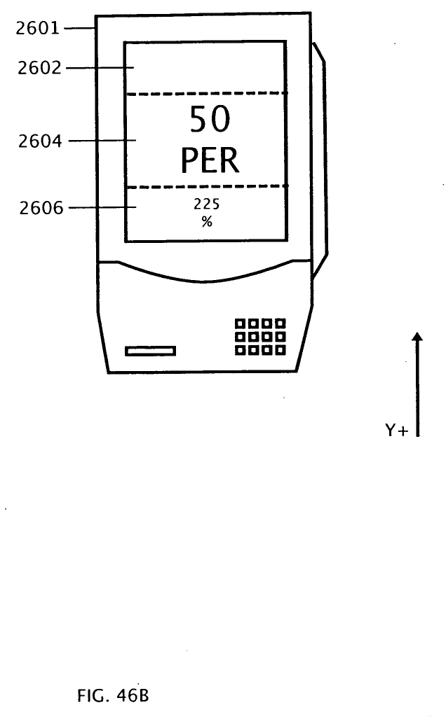

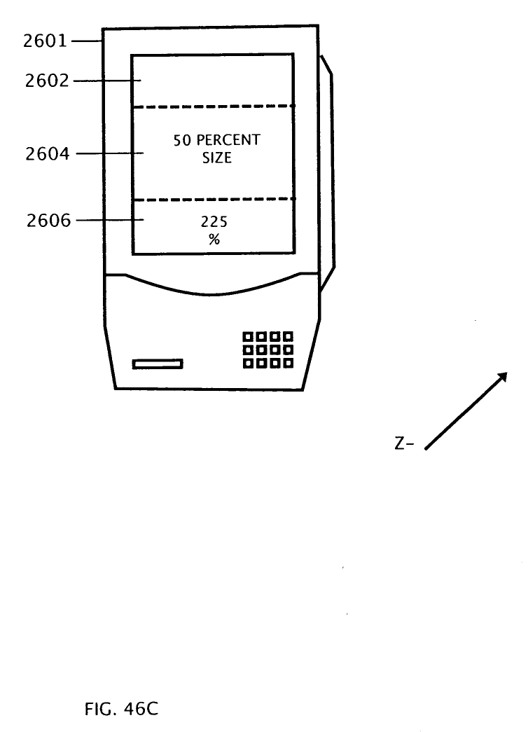

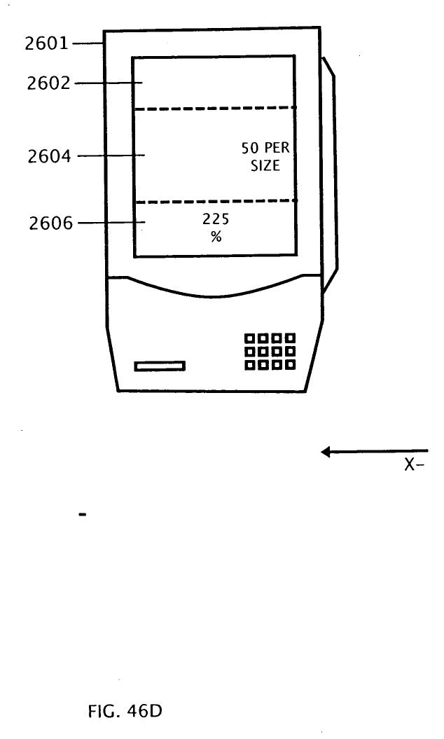

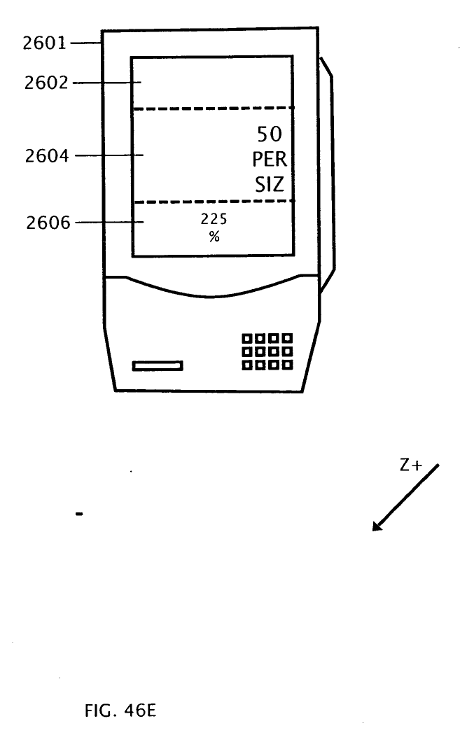

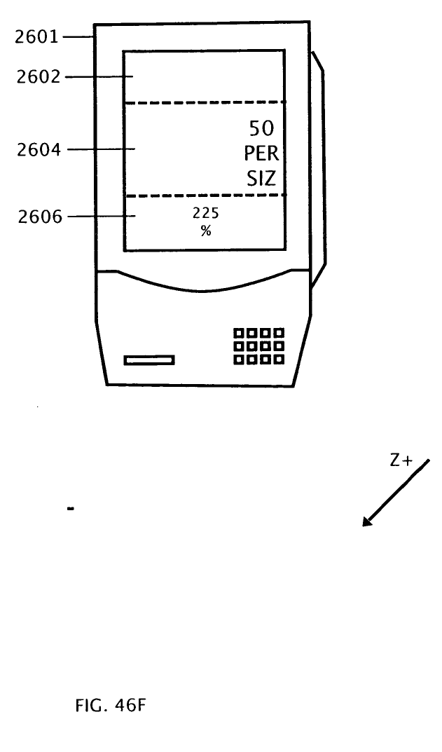

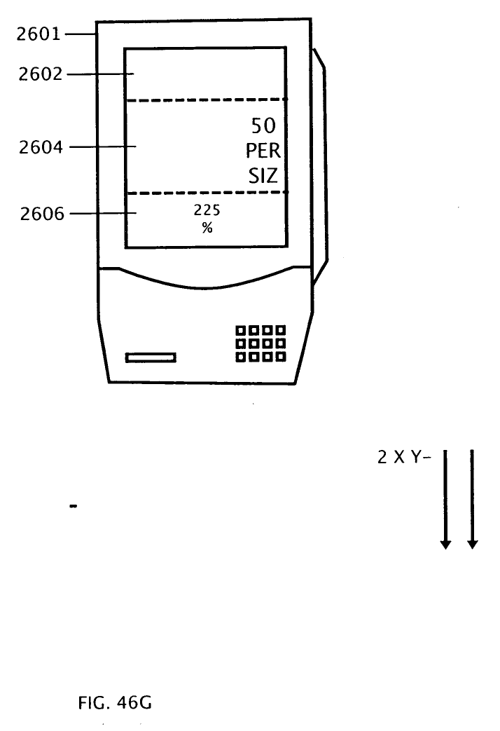

In another preferred embodiment the preference display has “zone” in which the specified region of the first frame is enlarged on the target device display. FIGS. 46A-G represent the displays characteristics of such a feature. The display conversion system 700, and the display preference setting system 900 implement this optional feature. FIG. 46A consists of a PDA or other target device display 2601, three “zones” 2602, 2604, and 2606. Zone 2604 would be the largest zone, approximately 2.5 inches by 1.5 inches tall, and in a 160×160 pixel display, would be 160 pixels wide by 96 pixels tall. Zones 2602 and 2606 would each be the same size approximately 2.5 by 0.5 inches or 160 pixels wide by 37 pixels high. The proportions are representative of an exemplary preferred embodiment and could be easily changed based on individual user preferences. Zone 2602 contains a possible content object 2610, zone 2604 contains possible content object 2612, and zone 2606 contains possible object content 2614. Optional zone divisional line 2616 and 2618 may be present to delineate the border of the zones. Zone 2604 would be the only zone subject to z-axis motion, which in the special command configuration would be movement in the back and forth direction away from and towards the user, thus enlarging or diminishing object 2612. Zones 2602 and 2606 would remain unchanged, but remain small, so the viewer could see the majority of the screen in a pseudo-preview format.

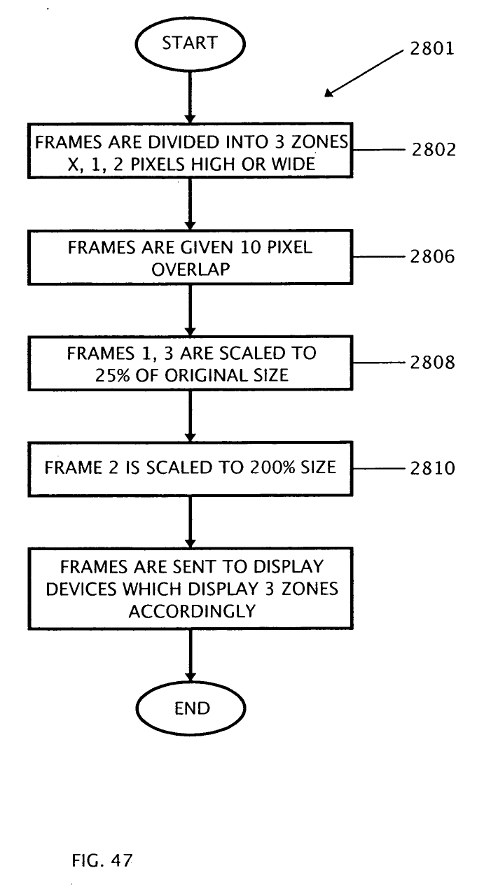

By performing the special discrete command of moving the PDA in the positive y-direction, the user would move object 2610 into zone 2604, thus enlarging it to the desired proportions. A user could set the magnification of zones 2602, 2604, and 2606 as desired, such as in the figure, 25%, 200%, and 25%, respectively. FIG. 47 represents the method by which the ZOOM ZONET™ is implemented by the user preference system 900, but optional features of the patent could be implemented on the PDA device itself 550 with the development of better memory capacity. In step 2801 the user preference system loads a zone proportion request, in step 2802 the output frame is divided into three (or optionally two or more than three) zones of a, b, and c pixels of height. In step 2806, each frame is given a 10 pixel overlap (or other appropriate marking). In step 2808, the top and bottom frames are scaled appropriately to a chosen percentage, in this case 25%. In step 2810, frame 2 is enlarged by 200%. In another exemplary option, in step 2801 the center zone is proportioned to the same dimensions as a normal computer screen, which is usually 4:3, in which case the center display zone would be 160 pixels wide by 120 pixels high and the two smaller zones would be 20 pixels high each.

In the preferred embodiment, one specific controlling motion in the y direction (positive or negative) may move the top frame into the center frame, and the center frame into the lower frame, and the z direction movement would affect the center frame only. Another preferred embodiment allows the process to be completed for vertical frame divisions and horizontal zoom zones, based on user preferences.

FIGS. 48A-D represent another preferred embodiment 2900 of the present invention in which the intuitive control is used to navigate the Internet or another document containing links. The diagrams 48A-D represent four sample PDA screens. System 2900 consists of a PDA screen 2902, four links on a first web page screen 2903-2906, a first graphic display screen 2909, a second set of links 2921 and 2922, and a second graphic display screen 2925. A user activates the alternate embodiment by pressing a control button 554 on the PDA device 550. The screen displays a first set of links 2903-2908, with link 2903 highlighted and a first graphic 2909 displayed. Upon a positive y-movement of the device (screen 2), the highlighted link moves to the lower link 2905. A movement in the negative x-direction (screen 3) moves the highlighted link to link 2906. A discrete movement in the positive z-direction (screen 4) causes an action as if a user clicked on a link and the second set of links 2921 and 2922 are displayed along with the second display screen 2925, with the first link 2921 highlighted. A movement of the device in the negative z-direction (screen 5) performs an action equivalent to pressing the “BACK” button on a computer screen browser and takes the screen back to the previous accessed screen. Link 2906 is still highlighted to show the user the link previously accessed. A movement in the negative y-direction (screen 6) will move the highlight 2950 to link 2904.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

Having thus described our invention, we claim:

1. A computer implemented method for displaying content on a target device display, comprised of the acts of
a. loading a first frame;
b. determining a set of parameters based on said first frame;
c. choosing a set of frame conversion algorithms based on a set of display requirements for a target device and said set of parameters based on said first frame;
d. generating a second frame by executing said set of frame conversion algorithms;
e. sending said second frame to a broadcasting system, said broadcasting system for sending and receiving data from a set of one or more of said target devices; and
f displaying said second frame on a display of said target device.

2. The method as recited in claim 1 wherein said target device is configured such that said target device will continually display a certain portion of a virtual desktop within said target device display such that a user can view said certain portion of said virtual desktop,
and said target device further configured such that said target device detects a tracked motion of said target device including discrete motion gestures initiated by said user,
and further configured such that when said tracked motion corresponds to a request for a special discrete command, performing said special discrete command.

3. The method as recited in claim 1, wherein said act of loading a first frame further comprises loading a first frame from a computer network.

4. The method as recited in claim 1, wherein said act of loading a first frame further comprises loading a first frame from the Internet.

5. The method as recited in claim 1, wherein said act of choosing a set of frame conversion algorithms further comprises an act of loading a set of user preferences, said set of user preferences for determining the presentation of said second frame on said target device display.

6. The method as recited in step 5, wherein said set of user preferences includes an orientation preference, said orientation preference for determining whether said second frame is presented on said target device display horizontally or vertically.

7. The method as recited in step 5, wherein said set of user preferences includes a scaling preference, said scaling preference for determining an amount of said second frame that will appear on said second target device display.

8. The method as recited in step 5, wherein said set of user preferences includes a location preference, said location preference for determining a point on said target device display, wherein a point on said second frame is placed.

9. The method as recited in step 5, wherein said set of user preferences includes a complexity preference, said complexity preference for determining a number of pixels per unit area that will be displayed on said target device display.

10. The method as recited in claim 1, wherein said set of frame conversion algorithms includes a graphics removal code segment which when executed removes a set of undesirable graphic elements from said first frame in creating said second frame.

11. The method as recited in claim 10, wherein said graphics removal code segment, when executed, performs the following additional acts:
a. creating a set of simplified graphic elements from said removed undesirable graphics elements; and
b. placing said simplified graphic elements in said second frame.

12. The method as recited in claim 10, wherein said act of removing is determined by a set of complexity parameters, said set of complexity parameters determined by a set of characteristics of said target device display.

13. The method as recited in claim 12, wherein one of said set of complexity parameters is a display screen resolution.

14. The method as recited in claim 1 wherein said set of conversion algorithms includes a code segment which removes a set of one or more colors from said first frame and replaces said set of one or more colors with a series of gray scales in said second frame.

15. The method as recited in claim 1, wherein said frame conversion algorithms includes a depth analysis code segment, which, when executed, analyzes said first frame for a set of depth features.

16. The method as recited in claim 15, wherein the frame conversion algorithms includes a depth creation code segment, which, when executed, enhances said set of depth features in creating said second frame.

17. The method as recited in claim 16 wherein said target device is configured such that it will continually display a certain portion of a virtual desktop within said target device display such that a user can view said certain portion of said virtual desktop,
and said target device further configured such that said target device tracks motion of said target device including discrete motion gestures initiated by said user,
and further configured such that when said tracked motion corresponds to a request for a special discrete command, performing said special discrete command,
and further configured such that said set of depth features is magnified upon the receipt of a particular said discrete command.

18. The method as recited in claim 1, wherein said target device has a geometric shape, and said set of display requirements for a target device are based on said geometric shape of said target device display screen.

19. The method as recited in claim 1, wherein said frame conversion algorithm includes a code segment, which when executed, perform the following acts
a. calculates the amount of times a said first frame length can be divided by a said display device length;
b. divides said first frame length by a number based on said calculation step;
c. calculates the amount of times a said first frame width can be divided by a said display device width;
d. creates a set of divided screens said first frame width by a number based on said calculation step;
e. creates a first part of said set of divided screens to a display on said target device; and target device.
f. creates a second part of said set of divided screens to store in a memory buffer in said target device.

20. The method as recited in claim 19, wherein said first part is loaded on a display device and said second part is loaded into a display memory buffer on said device.

21. The method as recited in claim 19 wherein said target device is configured such that it will continually display a certain portion of a virtual desktop within said target device display such that a user can view said certain portion of said virtual desktop,
said target device further configured such that the target device tracks motion of said target device including discrete motion gestures initiated by said user; and
further configured such that when said tracked motion corresponds to a request for a special discrete command, performing said special discrete command.

22. The method as recited in claims 21, wherein said display device is configured to display a first part of said divided screen, and further configured to display a second part upon receipt of a particular said special discrete command.

23. The method as recited in claim 1, wherein a set of first frames is loaded by said loading step at a loading frame rate, said loading frame rate determined by said set of parameters, and said frame conversion algorithms create a set of second frames at a sending frame rate, said sending frame rate determined by said set of display requirements.

24. The method as recited in claim 23, wherein said loading frame rate is equal to said sending frame rate.

25. The method as recited in claim 2, wherein a set of first frames is loaded by said loading step at a loading frame rate, said loading frame rate determined by said set of parameters, and said frame conversion algorithms cerate a set of second frames at a sending frame rate, said sending frame rate, wherein said sending frame rate is based on a set of one or more said special discrete commands.

26. A system for converting content from a computer network for display on a hand-held device comprising:
a) a CPU;
b) a first communications device, said first communications device for connecting to a computer network;
c) a frame loading code segment, executable at said system, said frame loading code segment for capturing a display, said display displayable on a computer connected to said computer network;
d) a frame converting code segment, executable at said system, said frame converting code segment for converting a frame from said display into a frame suitable for display on a hand-held device display;
e) a second communications device connected to a network of wireless devices.

27. The system as recited in claim 26, wherein said hand-held device display is configured such that said display will continually display a certain portion of a virtual desktop within a portable device display such that a user can view said certain portion of said virtual desktop, and said target device further configured such that a tracking motion of said portable display device includes at least one discrete motion gesture initiated by said user and further configured such that said at least one discrete motion gesture initiated by said user corresponds to a request for a special discrete command, said tracking motion performing said special discrete command.

28. A system as recited in claim 26, wherein said frame converting code segment further comprises a convolution code segment, said convolution code segment for transforming a set of at least one element, said set of at least one element belonging to said frame from a computer network.

29. A system as recited in claim 28, wherein said convolution code segment transforms said set of at least one element, said set of at least one element containing a color representation of at least one pixel.

30. A system as recited in claim 28, wherein said convolution code segment transforms said set of at least one element, said set of at least one element containing a geometric representation of at least one pixel.

31. A system as recited in claim 28, wherein said convolution code segment transforms said set of at least one element, said set of at least one element containing a scale representation of a set of pixels.

32. A system as recited in claim 28, wherein said convolution code segment transforms said set of at least one element, said set of at least one element containing a geometric representation of at least one pixel.

33. A system as recited in claim 28, wherein said convolution code segment transforms said set of at least one element, said set of at least one element containing a representation of a set of edges, said set of edges being a subset of said frame from a computer network.

34. The system as recited in claim 28, wherein said hand-held display device is further configured such that said virtual desktop on said wireless device display is split into a plurality of display regions.

35. The system as recited in claim 34, wherein said hand-held device is further configured to store a portion of said virtual desktop on said wireless device display which corresponds to said one of said plurality of display regions in memory.

36. The system as recited in claim 34, wherein only one of said plurality of display regions responds to said special discrete command.

37. The system as recited in claim 35, wherein said hand-held device is further configured such that a first region of said plurality of regions corresponding to a first portion of said one of said plurality of display regions stored in memory is switched with a second portion of said plurality of display regions stored in memory.

38. The system as recited in claim 37, wherein a said special discrete command activates said switching of regions in memory.

39. The system as recited in claim 28, wherein performing a said special discrete command scrolls a screen a predetermined portion of said virtual desktop, said predetermined portion calculated by said frame converting code segment.

40. The system as recited in claim 28, wherein a portion of the virtual desktop is highlighted, said highlighted portion calculated by said frame converting code segment.

41. A system as recited in claim 26 further comprised of a customizing code segment executable at said system for converting content, said customizing code segment for converting a set of graphics for display on a hand-held device based on a set of user-defined preferences.

42. A system as recited in claim 41, wherein said set of user defined preferences contain an orientation element, said orientation element for determining whether a display is horizontal or vertical or diagonal.

43. A system as recited in claim 41, wherein said set of user defined preferences contain an scaling element, said scaling element for determining the size of a display compared to the elements contained in said display.

44. A system as recited in claim 41, wherein said set of user defined preferences contain an scaling element, said scaling element for determining the size of a display compared to the elements contained in said display.

45. The system as recited in claim 26, wherein said frame from a computer network is an HTML web page.

46. The system as recited in claim 26, wherein said frame from a computer network is an XML web page.

47. The system as recited in claim 26, wherein said frame from a computer network is an DHTML web page.

48. The system as recited in claim 26, wherein said frame from a computer network contains a JAVA applet.

49. The system as recited in claim 26, wherein said frame from a computer network contains a Flash® segment.

50. The system as recited in claim 26, further comprised of a bill track code segment, said bill track code segment for calculating an amount of resources used.

51. The system as recited in claim 50, further comprised of an additional computer readable medium which can store said amount of resources used.

52. The system as recited in claim 50, wherein said amount of resources used is calculated in time units.

53. The system as recited in claim 50, wherein said amount of resources used is calculated in units of data.
